(19) United States
(12) Patent Application Publication
(10) Pub. No.: US 2017/0075631 A1
(43) Pub. Date: Mar. 16, 2017

(54) STORAGE SYSTEM, STORAGE CONTROL DEVICE, AND ACCESS CONTROL METHOD

(71) Applicant: FUJITSU LIMITED, Kawasaki-shi (JP)

(72) Inventors: Yasuhito Kikuchi, Kawasaki (JP); Akimasa Yoshida, Nagoya (JP)

(73) Assignee: FUJITSU LIMITED, Kawasaki-shi (JP)

(21) Appl. No.: 15/257,950

(22) Filed: Sep. 7, 2016

(30) Foreign Application Priority Data
Sep. 14, 2015 (JP) 2015-180599

(51) Int. Cl. G06F 3/06

(52) U.S. Cl. CPC G06F 3/0659; G06F 3/061; G06F 3/0683

(57) ABSTRACT

A storage control device that is used for a storage system, the storage control device including a memory, and a processor configured to acquire a first access result by accessing a first logical storage area included in a combined logical storage area upon receiving a first access request for the combined logical area, the combined logical storage area being a logical storage area combined the first logical storage area and a second logical storage area, transmit a second access request for an unaccessed area in the combined logical storage area to another storage control device, and transmit, upon receiving a second access result corresponding to the second access request transmitted from the another storage control device, a third access result corresponding to the first access request to the access source device based on the first access result and the second access result.

### CROSS-REFERENCE TO RELATED APPLICATION

This application is based upon and claims the benefit of priority of the prior Japanese Patent Application No. 2015-180599, filed on Sep. 14, 2015, the entire contents of which are incorporated herein by reference.

### FIELD

The embodiments discussed herein are related to a storage system, a storage control device, and an access control method.

### BACKGROUND

At present, a storage system is used for storing data. The storage system includes memory devices such as hard disk drives (HDD) or solid state drives (SSD) and makes available a large-capacity memory area. The storage system includes a storage control device to perform access control of writing and reading of data to and from memory devices. In some cases, the storage system is equipped with storage control devices so as to decentralize or make redundant data access and improves the performance or reliability of the data access.

There is a proposal for providing, to a client device, a logical directory configuration in which directory configurations included in respective file sharing devices are virtually unified, for example.

In addition, there is a proposal of a virtual disk system that includes units each including, for example, physical drives and respective access control circuits therefor and in which the units each translate a logical address of a virtual drive, sent from a higher-level device, to a physical address of a physical drive. In this proposal, in a case where one of the units receives a request to access a physical drive of another one of the units, the relevant access request is transferred to the other unit. The other unit establishes coupling to the higher-level device in accordance with the transferred access request and performs writing of data to the physical drive, or the like, thereby responding to the higher-level device with a completion report.

As technologies of the related art, there are Japanese Laid-open Patent Publication No. 2009-3499 and Japanese Laid-open Patent Publication No. 7-152491.

### SUMMARY

According to an aspect of the invention, a storage system including a plurality of storage device groups, a first processor coupled to a first storage device groups included in the plurality of storage device groups and the first processor configured to acquire a first access result by accessing a first logical storage area included in a combined logical storage area upon receiving a first access request for the combined logical area, the combined logical storage area being a logical storage area combined the first logical storage area and a second logical storage area, the first logical storage area being a logical storage area corresponding to the first storage device groups, the second logical storage area being a logical storage area corresponding to a second storage device groups included in the plurality of storage device groups, the first access request being transmitted from an access source device, transmit a second access request for an unaccessed area in the combined logical storage area; and transmit, upon receiving a second access result corresponding to the second access request, a third access result corresponding to the first access request to the access source device based on the first access result and the second access result; and a second processor coupled to the second storage device groups and the second processor configured to acquire the second access result by accessing the second logical storage area corresponding to the unaccessed area upon receiving the second access request, and transmit the second access result to the first processor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a storage system of a first embodiment;

FIG. 2 is a diagram illustrating a storage system of a second embodiment;

FIG. 3 is a diagram illustrating examples of nodes included in shelves;

FIG. 4 is a diagram illustrating examples of hardware of nodes;

FIG. 5 is a diagram illustrating an example of hardware of a controller unit;

FIG. 6 is a diagram illustrating an example of hardware of a business server;

FIG. 7 is a diagram illustrating examples of functions of controller units;

FIG. 8 is a diagram illustrating an example of a virtual volume;

FIG. 9 is a diagram illustrating an example of allocation of logical segments to a virtual volume;

FIG. 10 is a diagram illustrating an example of IO processing performed on a virtual volume;

FIG. 11 is a diagram illustrating an example of creation of virtual volumes;

FIG. 12 is a diagram illustrating examples of tables held by individual nodes;

FIG. 13 is a diagram illustrating an example of an island master address management table;

FIG. 14 is a diagram illustrating an example of a virtual volume management table;

FIGS. 15A and 15B are diagrams each illustrating an example of a node address management table;

FIGS. 16A and 16B are diagrams each illustrating an example of a node-in-charge management table;

FIG. 17 is a diagram illustrating an example of a translation table (part one);

FIGS. 18A and 18B are diagrams each illustrating an example of a translation table (part two);

FIG. 19 is a diagram illustrating an example of information included in a login request;

FIG. 20 is a diagram illustrating an example of a first sequence of virtual volume creation;

FIG. 21 is a diagram illustrating an example of a second sequence of virtual volume creation;

FIG. 22 is a diagram illustrating an example of a first sequence of I/O processing;

FIG. 23 is a diagram illustrating an example of a second sequence of I/O processing;

FIG. 24 is a diagram illustrating an example of the second sequence (the rest thereof) of the I/O processing;

FIG. 25 is a diagram illustrating an example of a third sequence of I/O processing;

FIG. 26 is a diagram illustrating an example of the third sequence (the rest thereof) of the I/O processing; and

FIG. 27 is a flowchart illustrating an example of I/O processing based on a node in charge.

### DESCRIPTION OF EMBODIMENTS

It is considered that, in a storage system, sets (memory device groups) each including memory devices are provided and for each one of the memory device groups, 1 or more storage control devices that are each in charge of accesses to the corresponding one of the memory device groups are provided. Then, it is possible to realize a flexible operation in such a manner as providing an independent logical area in each of the memory device groups or scaling out in units of groups of memory device groups and storage control devices.

Here, it is considered that by combining logical areas created for respective memory device groups, a logical area (virtual volume) that straddles memory device groups is created. However, in this case, a request to access an area that straddles memory device groups and that is included in the virtual volume may be generated. Even if, for example, one of the storage control devices receives the relevant access request, it is difficult to access a portion of which the storage control device itself is not in charge, and an access is liable to be interrupted. Therefore, how to realize a mechanism for enabling an access request to be adequately processed so as not to interrupt an access comes to an issue.

In one aspect, an object to the present technology is to provide a storage system, a storage control device, and an access control method that are each capable of adequately processing an access request.

Hereinafter, the present embodiment will be described with reference to drawings.

### First Embodiment

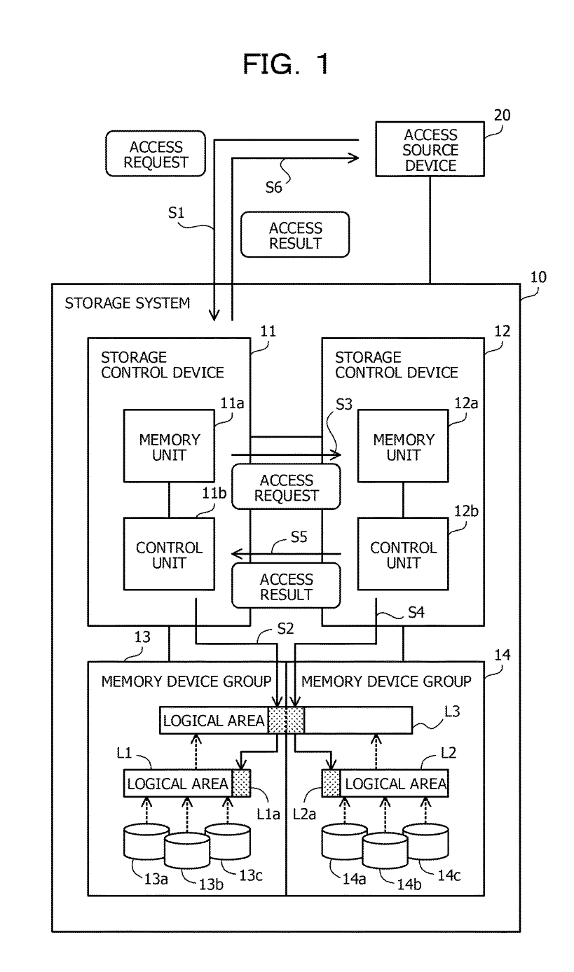

FIG. 1 is a diagram illustrating a storage system of a first embodiment. A storage system 10 includes memory devices such as HDDs or SSDs and memorizes data by using the memory devices. The storage system 10 is coupled to an access source device 20. The access source device 20 is, for example, an information processing device to perform business processing by using data stored in the storage system 10.

The storage system 10 includes storage control devices 11 and 12 and memory device groups 13 and 14. The storage control devices 11 and 12 are communicatable with each other. The storage control device 11 is in charge of accesses to (writing and reading of data to and from) the memory device group 13. The storage control device 12 is in charge of accesses to the memory device group 14. The storage control device 11 may be called a first storage control device. The storage control device 12 may be called a second storage control device.

Each of the memory device groups 13 and 14 is a set of memory devices. The memory device group 13 includes memory devices 13a, 13b, and 13c. The memory device group 14 includes memory devices 14a, 14b, and 14c. The memory device group 13 may be called a first memory device group. The memory device group 14 may be called a second memory device group.

The storage control device 11 combines portions of memory areas of the respective memory devices 13a, 13b, and 13c and creates a logical area L1. The storage control device 12 combines portions of memory areas of the memory devices 14a, 14b, and 14c and creates a logical area L2. In this case, the storage control device 11 turns out to be in charge of accesses to the logical area L1. The storage control device 12 turns out to be in charge of accesses to the logical area L2.

Furthermore, the storage control device 11 creates a logical area L3 obtained by combining the logical areas L1 and L2. The storage control device 11 enables the access source device 20 to reference the logical area L3. In, for example, the storage system 10, the storage control device 11 receives a request to access the logical area L3, issued by the access source device 20.

The storage control device 11 includes a memory unit 11a and a control unit 11b. The storage control device 12 includes a memory unit 12a and a control unit 12b. The memory units 11a and 12a may be volatile memory devices such as random access memories (RAMs) or may be non-volatile memory device such as HDDs or flash memories. The control units 11b and 12b may each include a central processing unit (CPU), a digital signal processor (DSP), an application specific integrated circuit (ASIC), a field programmable gate array (FPGA), and so forth. Each of the control units 11b and 12b may be a processor to execute a program. The term “processor” hare may include a set of processors (multiprocessor).

The memory unit 11a memorizes association information between physical addresses indicating memory positions of the respective memory devices 13a, 13b, and 13c and logical addresses in the logical area L1. The memory unit 11a memorizes association information between logical addresses in the logical area L1 and logical addresses in the logical area L3. In addition, the memory unit 11a memorizes association information between the logical area L3 and the logical areas L1 and L2 and association information between the logical area L2 and identification information of the storage control device 12 to manage the logical area L2.

Here, in the same way as the memory unit 11a, the memory unit 12a memorizes association information between physical addresses indicating memory positions of the respective memory devices 14a, 14b, and 14c and logical addresses in the logical area L2, the storage control device 12 being in charge of accesses to the memory devices 14a, 14b, and 14c. In addition, the memory unit 12a memorizes association information between logical addresses in the logical area L2 and logical addresses in the logical area L3.

Upon receiving a request to access the logical area L3, issued by the access source device 20, the control unit 11b executes an access to the logical area L3. The access to the logical area L3 may be an access to the entire logical area L3. The access to the logical area L3 may be an access to a logical address range of a portion of the logical area L3. At his time, the access source device 20 may issue, as a request to access the logical area L3, a first access request for requesting an access that straddles a boundary between the logical areas L1 and L2.

The first access request includes the logical area L3 which is to serve as an access target and information for identifying a logical address range of the logical area L3. A first portion of the relevant logical address range of the logical area L3 corresponds to a portion L1a of the logical area L1, and a second portion thereof corresponds to a portion L2a of the logical area L2. In this case, the control units 11b and 12b process the first access request as follows.

First, the control unit 11b receives the first access request issued by the access source device 20 (step S1). Then, based on the association information, memorized by the memory unit 11a, between logical addresses of the logical area L3 and the logical area L1, the control unit 11b accesses the portion L1a of the logical area L1 (step S2). At this time, based on the association information, memorized by the memory unit 11a, between the logical addresses of the logical area L1 and the physical addresses of the memory devices 13a, 13b, and 13c, the control unit 11b is able to identify physical address groups on the memory devices 13a, 13b, and 13c, which correspond to the portion L1a.

In this way, regarding a logical address range that corresponds to the portion L1a and that is included in the logical address range of the logical area L3, requested by the first access request, the control unit 11b acquires a first access result. In a case of, for example, writing of data, the first access result is information indicating that writing is performed on some pieces of data requested by the first access request, and in a case of reading of data, the first access result is a read result of some pieces of the data requested by the first access request.

The control unit 11b detects that there is a portion not yet accessed (unaccessed portion) that is different from the portion L1a of which the storage control device 11 is in charge, the unaccessed portion being included in the logical address range of the logical area L3, requested by the first access request. Then, by referencing the association information between the logical area L3 and the logical areas L1 and L2 and the association information between the logical area L2 and the storage control device 12, the two pieces of association information being memorized by the memory unit 11a, the control unit 11b determines that the unaccessed portion is managed by the storage control device 12. In addition, the control unit 11b generates and transmits, to the storage control device 12, a second access request for the unaccessed portion of the logical area L3 (step S3). At this time, the control unit 11b turns out to establish, with the storage control device 12, a connection for data access. Before the establishment of the connection, the control unit 11b may perform predetermined login processing on the storage control device 12 (the control unit 11b functions as, for example, an initiator and logs in the storage control device 12 serving as a target, or the like).

The control unit 12b receives the second access request issued by the storage control device 11. Then, based on the association information, memorized by the memory unit 12a, between logical addresses of the logical area L3 and the logical area L2, the control unit 12b accesses the portion L2a of the logical area L2 (step S4). At this time, based on the association information, memorized by the memory unit 12a, between the logical addresses of the logical area L2 and the physical addresses of the memory devices 14a, 14b, and 14c, the control unit 12b is able to identify physical address groups on the memory devices 14a, 14b, and 14c, which correspond to the portion L2a. In addition, the portion L2a corresponds to a portion that is not yet accessed on the storage control device 11 side and that is included in the address range of the logical area L3, requested by the first access request.

In this way, the control unit 12b acquires a second access result for the second access request. In a case of, for example, writing of data, the second access result is information indicating that writing is performed on the data requested by the second access request (in other words, data of the remaining portion of the data requested by the first access request). Alternatively, in a case of reading of data, the second access result is a read result of the data requested by the second access request (in other words, a read result of the remaining portion of the data requested by the first access request). The control unit 12b transmits the second access result to the storage control device 11 (step S5).

The control unit 11b receives the second access result from the storage control device 12. Based on the first access result and the second access result, the control unit 11b generates a third access result for the first access request. If the first access request is, for example, a write request for data, the third access result is information indicating that writing of the relevant data to the logical area L3 is completed. In addition, if the first access request is, for example, a read request for data, the third access result is the relevant data read from the logical area L3 (data obtained by combining the first access result (a read result) and the second access result (a read result)). The control unit 11b transmits the generated third access result to the access source device 20 (step S6).

In this way, the storage control device 11 is able to adequately process an access to straddle the boundary that is located between the logical areas L1 and L2 ant that is included in the logical area L3. Specifically, it goes as follow. In, for example, the storage control device 11, upon receiving the first access request issued by the access source device 20, it is possible to access a portion that is included in the logical area L1 and that is included in the logical area L3, by using the association information held by the storage control device 11. However, since being outside the responsibility of accesses based on the storage control device 11, a portion (remaining portion) that is included in the logical area L2 and that is included in the logical area L3 is difficult to access based on the storage control device 11. Then, it is difficult for the storage control device 11 to access the relevant remaining portion, and access processing for the first access request turns out to be interrupted.

It is considered that, after, for example, the interruption, the access source device 20 causes coupling with the storage control device 12 to be established, the storage control device 12 executes an access to the remaining portion, and the storage control device 12 responds to the access source device 20 with an access result of the remaining portion. However, in this method, not only the access source device 20 is forced to perform processing for coupling establishment such as login processing for the storage control device 12 and issuing of another access request, but also it is difficult to avoid interruption of an access based on the first access request.

Therefore, for the first access request, the storage control device 11 executes an access to a portion of the logical area L3, processable by the storage control device 11, and transmits, to the storage control device 12, an access request for a remaining portion. By combining the first access result based on the storage control device 11 and the second access result based on the storage control device 12, the storage control device 11 generates the third access result for the first access request and responds to the access source device 20 therewith. From this, an influence on the access source device 20 is reduced without interrupting an access, and it is possible to adequately process the first access request.

Note that another storage control device that manages a correspondence relationship between the logical areas L1 and L2 and the logical area L3 and storage control devices to control the logical areas L1 and L2 may be provided separately from the storage control devices 11 and 12. In this case, as a transmission destination of the first access request, the other storage control device may provide, to the access source device 20, a communication address (for example, an Internet protocol (IP) address or the like) of the storage control device 11. In addition, by making an inquiry at another storage control device, the storage control device 11 may acquire the communication address of the storage control device 12 serving as a transmission destination of the second access request.

### Second Embodiment

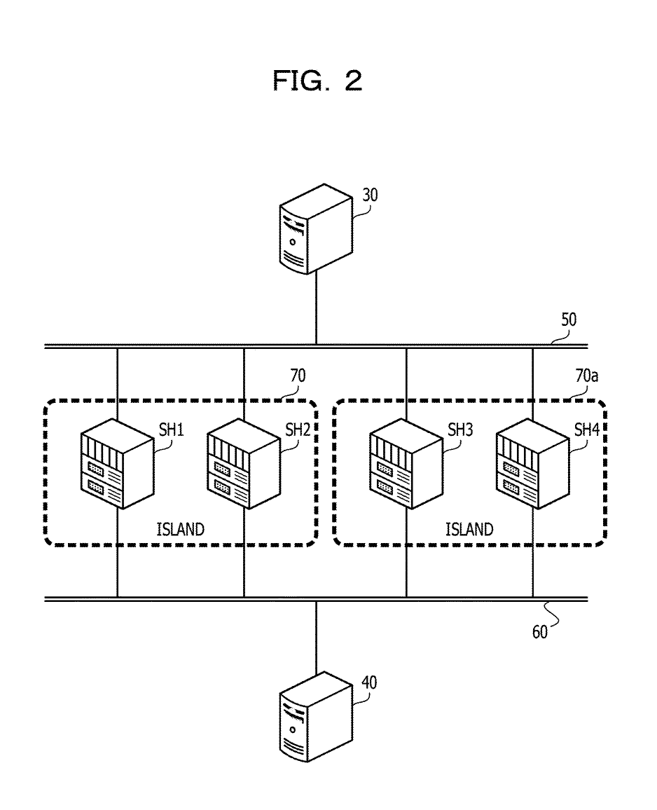

FIG. 2 is a diagram illustrating a storage system of a second embodiment. The storage system of the second embodiment includes shelves SH1, SH2, SH3, and SH4, a business server 30, and a management server 40. The shelves SH1, SH2, SH3, and SH4 and the business server 30 are coupled to a storage area network (SAN) 50. The shelves SH1, SH2, SH3, and SH4 and the management server 40 are coupled to a local area network (LAN) 60.

Each of the shelves SH1, SH2, SH3, and SH4 is an enclosure equipped with nodes to memorize data. The shelves SH1, SH2, SH3, and SH4 are grouped. One group is called one island. Specifically, the shelves SH1 and SH2 belong to an island 70. The shelves SH3 and SH4 belong to an island 70a.

In the storage system of the second embodiment, it is possible to create an independent logical area (called a virtual volume) for each of the islands. In addition, it is possible to create a virtual volume to straddle islands.

The business server 30 is a server computer that accesses, via the SAN 50, data stored in the shelves SH1, SH2, SH3, and SH4 and that performs business processing by using the relevant data.

The management server 40 is a server computer that manages virtual volumes in the islands 70 and 70a. By operating, for example, the management server 40, an administrator of the system is able to perform operations such as creation of a new virtual volume and capacity enhancement and performance improvement, based on scaling out in units of shelves.

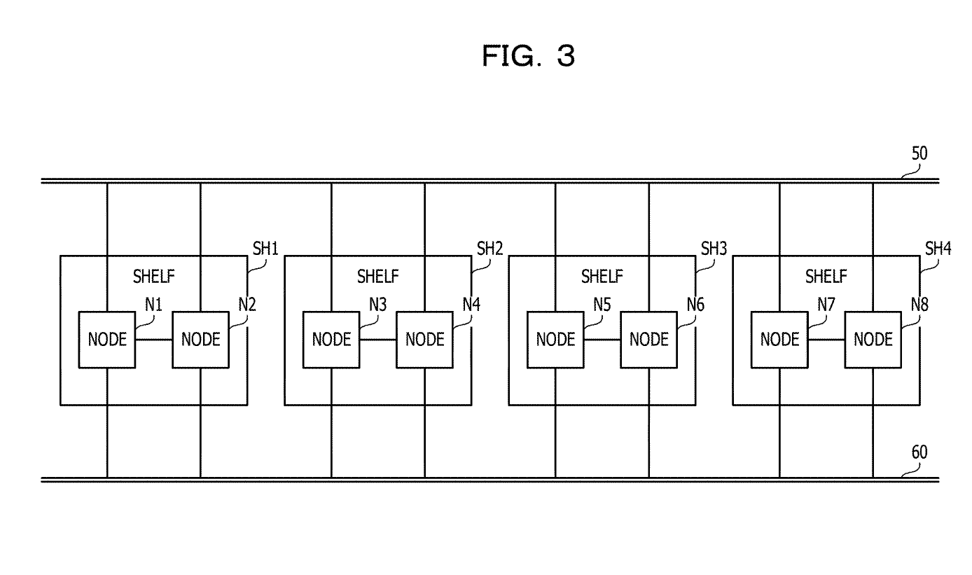

FIG. 3 is a diagram illustrating examples of nodes included in shelves. The shelf SH1 includes nodes N1 and N2. The shelf SH2 includes nodes N3 and N4. The shelf SH3 includes a node N5 and a node N6. The shelf SH4 includes nodes N7 and N8. Since the shelves SH1 and SH2 belong to the island 70, it may be said that the nodes N1, N2, N3, and N4 belong to the island 70. In the same way, since the shelves SH3 and SH4 belong to the island 70a, it may be said that the nodes N5, N6, N7, and N8 belong to the island 70a.

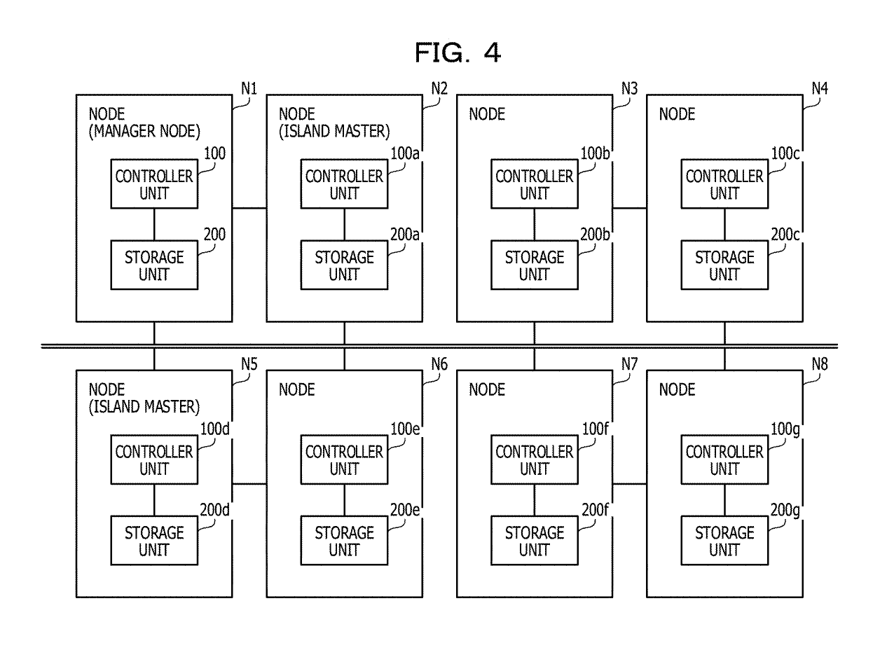

FIG. 4 is a diagram illustrating examples of hardware of nodes. The node N1 includes a controller unit 100 and a storage unit 200. The controller unit controls an access to data. The controller unit 100 is an example of the storage control devices 11 and 12 of the first embodiment. The storage unit 200 includes memory devices such as HDDs or SSDs. In the same way as the node N1, the nodes N2, N3, N4, N5, N6, N7, and N8 each include a controller unit and a storage unit.

Specifically, the node N2 includes a controller unit 100a and a storage unit 200a. The node N3 includes a controller unit 100b and a storage unit 200b. The node N4 includes a controller unit 100c and a storage unit 200c. The node N5 includes a controller unit 100d and a storage unit 200d. The node N6 includes a controller unit 100e and a storage unit 200e. The node N7 includes a controller unit 100f and a storage unit 200f. The node N8 includes a controller unit 100g and a storage unit 200g. The individual controller units turn out to be coupled to the SAN 50 and the LAN 60 (simplified and illustrated by using one network line in FIG. 4).

Here, in the storage system of the second embodiment, the node N1 is a node (called a manager node, in some cases) that manages virtual volumes created by the islands 70 and 70a.

In addition, the node N2 is a node (called an island master, in some cases) that manages a node (called a node in charge, in some cases) in charge of accesses to a virtual volume within the island 70. The node N5 is an island master to manage a node in charge that is in charge of accesses to a virtual volume within the island 70a.

In this regard, however, functions of both the manager node and the island master may be provided in a same node. Furthermore, the manager node or the island master functions as a node in charge, in some cases.

Note that the controller units are each called a processor unit in some cases. In addition, since the island 70 includes the storage units of the respective nodes N1, N2, N3, and N4, it may be said that the island 70 includes memory devices (a memory device group) included in each of the storage units. Since the island 70a includes the storage units of the respective node N5, N6, N7, and N8, it may be said that the island 70 includes memory devices (a memory device group) included in each of the storage units.

In addition, two controller units belonging to a same shelf may have redundancy configurations. If the node N1 is out of order in, for example, the shelf SH1, the node N2 is able to perform processing based on the node N1 as an alternative thereto (the same applies to the other shelves).

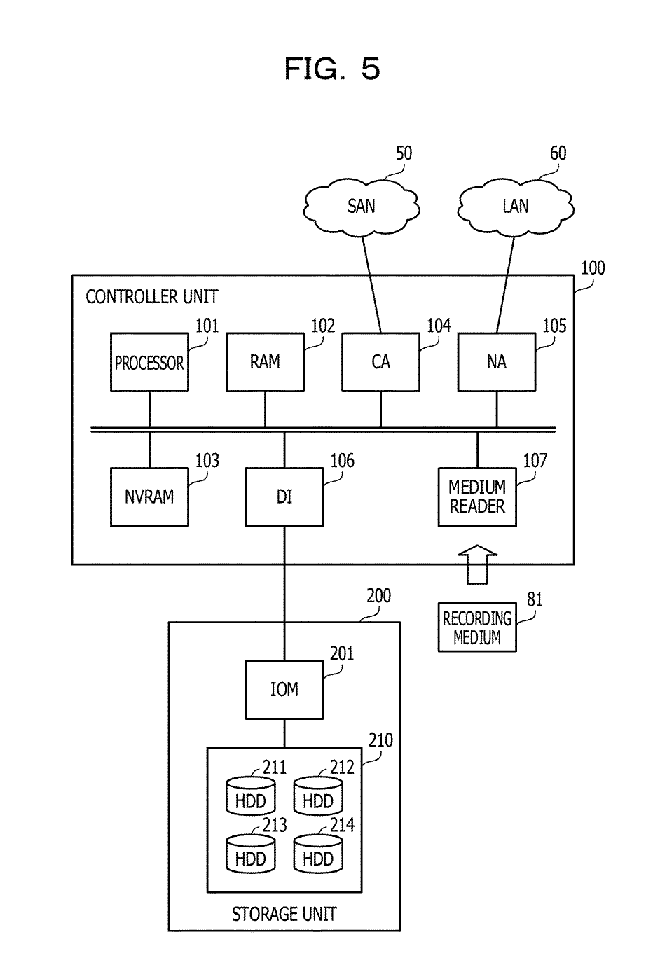

FIG. 5 is a diagram illustrating an example of hardware of a controller unit. The controller unit 100 includes a processor 101, a RAM 102, a non-volatile RAM (NVRAM) 103, a channel adapter (CA) 104, a network adapter (NA) 105, a drive interface (DI) 106, and a medium reader 107. The controller unit included in each of the other nodes may be realized by using the same hardware as that of the controller unit 100.

The processor 101 controls information processing based on the controller unit 100. The processor 101 may be a multiprocessor. The processor 101 is, for example, a CPU, a DSP, an ASIC, an FPGA, or the like. The processor 101 may be a combination of 2 or more elements of the CPU, the DSP, the ASIC, the FPGA, and so forth.

The RAM 102 is a main memory device of the controller unit 100. The RAM 102 temporarily memorizes at least some of firmware programs caused to be executed by the processor 101. In addition, the RAM 102 memorizes various kinds of data used for processing based on the processor 101.

The NVRAM 103 is an auxiliary memory device of the controller unit 100. The NVRAM 103 is, for example, a non-volatile semiconductor memory. The NVRAM 103 memorizes firmware programs, various kinds of data, and so forth.

The CA 104 is an interface for communicating with the business server 30 via the SAN 50. Here, as an example, it is assumed that the CA 104 is an interface of an internet small computer system interface (iSCSI). In this case, the SAN 50 may be called an IP-SAN. In this regard, however, as the CA 104, another interface such as a Fibre Channel (FC) may be used.

The NA 105 is an interface for communicating with the management server 40 via the LAN 60. As the NA 105, an interface of, for example, Ethernet (registered trademark) may be used.

The DI 106 is an interface for communicating with the storage unit 200. As the DI 106, an interface such as, for example, a serial attached SCSI (SAS) may be used. In order to realize a redundancy configuration with the controller unit 100a, the DI 106 may be coupled to the storage unit 200a.

The medium reader 107 is a device for reading a program and data recorded in a portable recording medium 81. As the recording medium 81, a non-volatile semiconductor memory such as, for example, a flash memory may be used. In accordance with an instruction from, for example, the processor 101, the medium reader 107 is able to store, in the RAM 102 or the NVRAM 103, the program and the data read from the recording medium 81.

Note that the controller unit 100 includes a predetermined interface for communicating with the controller unit 100a within the shelf SH1 and is coupled to the controller unit 100a via the relevant interface.

The storage unit 200 includes an input/output module (IOM) 201 and a memory device group 210. Storage units included in the other nodes may be each realized by using the same hardware as that of the storage unit 200. In accordance with an instruction from the controller unit 100, the IOM 201 performs data accesses to HDDs 211, 212, 213, and 214. The memory device group 210 is a set of HDDs. The memory device group 210 includes the HDDs 211, 212, 213, and 214.

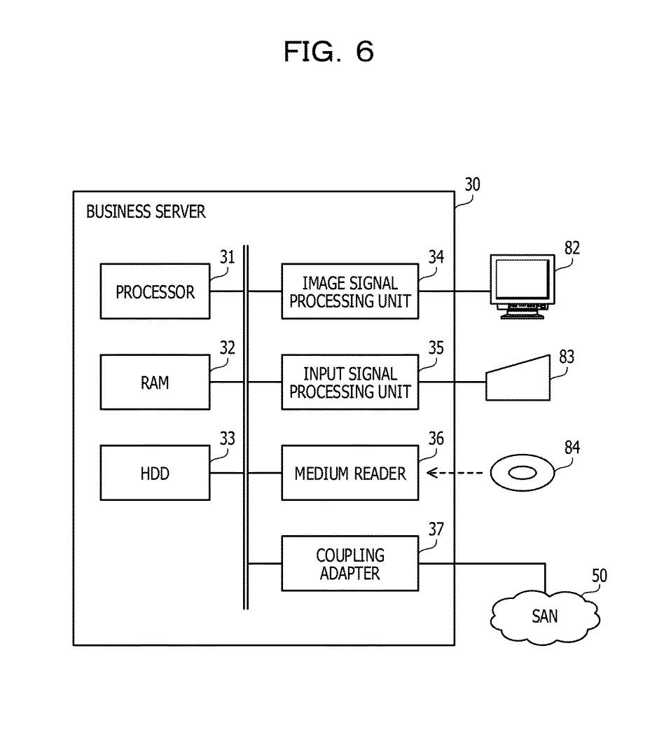

FIG. 6 is a diagram illustrating an example of hardware of a business server. FIG. 6 is a diagram illustrating an example of hardware of the business server 30. The business server 30 includes a processor 31, a RAM 32, an HDD 33, an image signal processing unit 34, an input signal processing unit 35, a medium reader 36, and a coupling adapter 37. The individual units are coupled to a bus of the business server 30. The management server 40 may be realized by using the same units as those of the business server 30.

The processor 31 controls information processing based on the business server 30. The processor 31 may be a multiprocessor. The processor 31 is, for example, a CPU, a DSP, an ASIC, an FPGA, or the like. The processor 31 may be a combination of 2 or more elements of the CPU, the DSP, the ASIC, the FPGA, and so forth.

The RAM 32 is a main memory device of the business server 30. The RAM 32 temporarily memorizes at least some of an operating system (OS) program and application programs caused to be executed by the processor 31. In addition, the RAM 32 memorizes various kinds of data used for processing based on the processor 31.

The HDD 33 is an auxiliary memory device of the business server 30. The HDD 33 magnetically performs writing and reading of data on an embedded magnetic disk. The HDD 33 memorizes the OS program, application programs, and various kinds of data. The business server 30 may include another type of auxiliary memory device such as a flash memory or an SSD or may include auxiliary memory devices.

In accordance with an instruction from the processor 31, the image signal processing unit 34 outputs images to a display 82 coupled to the business server 30. As the display 82, a cathode ray tube (CRT) display, a liquid crystal display, or the like may be used.

The input signal processing unit 35 acquires an input signal from an input device 83 coupled to the business server 30 and outputs the input signal to the processor 31. As the input device 83, for example, a pointing device such as a mouse or a touch panel, a keyboard, or the like may be used.

The medium reader 36 is a device for reading a program and data recorded in a recording medium 84. As the recording medium 84, for example, a magnetic disk such as a flexible disk (FD) of an HDD, an optical disk such as a compact disc (CD) or a digital versatile disc (DVD), or a magneto-optical disk (MO) may be used. In addition, as the recording medium 84, for example, a non-volatile semiconductor memory such as a flash memory card may be used. In accordance with an instruction from, for example, the processor 31, the medium reader 36 stores, in the RAM 32 or the HDD 33, the program and the data read from the recording medium 84.

The coupling adapter 37 is an interface for accessing a virtual volume via the SAN 50. The coupling adapter 37 is, for example, an iSCSI adapter. In this regard, however, in a case of using an FC for the SAN 50, an FC adapter may be used as the coupling adapter 37. Note that the business server 30 may include a communication interface for coupling to the LAN 60 and communicating with another computer.

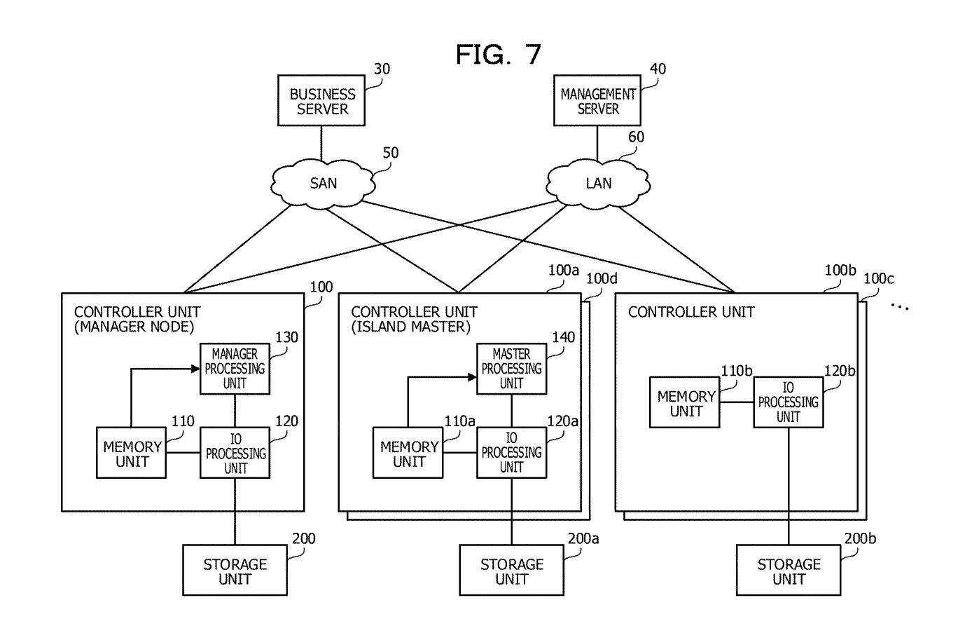

FIG. 7 is a diagram illustrating examples of functions of controller units. As described above, the node N1 functions as a manager node. In addition, the nodes N2 and N5 each function as an island master. Therefore, the controller unit 100 is different from the other controller units in including a function (manager function) of the manager node. In addition, the controller units 100a and 100d are each different from the other controller units in including a function (master function) of the island master.

The controller unit 100 includes a memory unit 110, an input/output (IO) processing unit 120, and a manager processing unit 130. The memory unit 110 may be realized as a memory area secured in the RAM 102 or the NVRAM 103. The processor 101 executes programs memorized by the RAM 102, thereby enabling the I/O processing unit 120 and the manager processing unit 130 to be realized.

The memory unit 110 memorizes information of a correspondence relationship between a virtual volume and an island to which the relevant virtual volume belongs. In addition, the memory unit 110 memorizes address information of the individual island masters. In an example of the second embodiment, since the SAN 50 is an IP-SAN, address used for communication of the SAN 50 are IP addresses. If the SAN 50 is an FC-SAN utilizing an FC, World Wide Names (WWNs) may be used as addresses.

In addition, addresses used for communication on an LAN 60 side (mainly used for communication between nodes) are IP addresses. In addition, the memory unit 110 memorizes information of a correspondence relationship (called a translation table) between logical addresses of a virtual volume and physical addresses on HDDs included in the storage unit 200.

Based on the translation table memorized by the memory unit 110, the I/O processing unit 120 executes an access to the storage unit 200. The I/O processing unit 120 divides, for example, a received access request (simply called an IO in some cases) and reads requested data from the storage unit 200 or writes data to the storage unit 200.

The manager processing unit 130 carries the manager function of the controller unit 100. Specifically, the manager processing unit 130 provides a virtual volume to the business server 30. Therefore, in order to access a virtual volume of the second embodiment, first the business server 30 issues a login request to the controller unit 100. In the login request, for the manager processing unit 130, the business server 30 is able to specify identification information of the virtual volume and a logical block address (LBA) from which an access is to be started. Then, the manager processing unit 130 sends, as a substitute, a login request to an island master used for accessing the corresponding virtual volume and causes the island master to redirect an access destination of the business server 30 to a node in charge of the relevant virtual volume.

In addition, in accordance with an instruction of the management server 40, the manager processing unit 130 controls creation of virtual volumes within the respective islands 70 and 70a. The manager processing unit 130 may create a virtual volume to straddle the islands 70 and 70a. In a case of creating a new virtual volume, the manager processing unit 130 creates and stores, in the memory unit 110, information of a correspondence relationship between a virtual volume and an island to which the relevant virtual volume belongs.

The controller unit 100a includes a memory unit 110a, an I/O processing unit 120a, and a master processing unit 140. The memory unit 110a may be realized as a memory area secured in a RAM or an NVRAM included in the controller unit 100a. A processor included in the controller unit 100a executes programs memorized by the RAM included in the controller unit 100a, thereby enabling the I/O processing unit 120a and the master processing unit 140 to be realized.

Here, since the functions of the memory unit 110a and the I/O processing unit 120a are the same as those of the memory unit 110 and the I/O processing unit 120, respectively, descriptions thereof will be omitted. In this regard, however, the memory unit 110a is different from the memory unit 110 in that the memory unit 110a memorizes information of a correspondence relationship between a virtual volume and a node in charge to be in charge of accesses to the virtual volume (information used for processing based on the corresponding island master) and does not have to memorize information used for processing based on the manager processing unit 130.

The master processing unit 140 carries the master function of the controller unit 100a. Specifically, for the login request (transferred by the manager processing unit 130) received from the business server 30, the master processing unit 140 provides, to the business server 30, an IP address of the node to be in charge of accesses to the virtual volume. Then, by establishing a connection with the node whose IP address is provided, the business server 30 is able to issue an IO to the relevant node. In some case, the master processing unit 140 receives a login request (transferred by the manager processing unit 130) from another controller unit and provides, to the relevant other controller unit, an IP address of a node to be in charge of accesses to a virtual volume.

Note that the controller unit 100d functioning as an island master has the same function as that of the controller unit 100a.

The controller unit 100b includes a memory unit 110b and an I/O processing unit 120b. The memory unit 110b may be realized as a memory area secured in a RAM or an NVRAM included in the controller unit 100b. A processor included in the controller unit 100b executes a program memorized by the RAM included in the controller unit 100b, thereby enabling the I/O processing unit 120b to be realized.

Here, since the functions of the memory unit 110b and the I/O processing unit 120b are the same as those of the memory unit 110 and the I/O processing unit 120, respectively, descriptions thereof will be omitted. In this regard, however, the memory unit 110b is different from the memory unit 110 or the memory unit 110a in that the memory unit 110b does not have to memorize information used for processing based on the manager processing unit 130 or the master processing unit 140. In addition, the controller units 100c, 100e, 100f, and 100g each have the same function as that of the controller unit 100b. Furthermore, the individual controller units each memorize an IP address of the controller unit 100 functioning as the manager node.

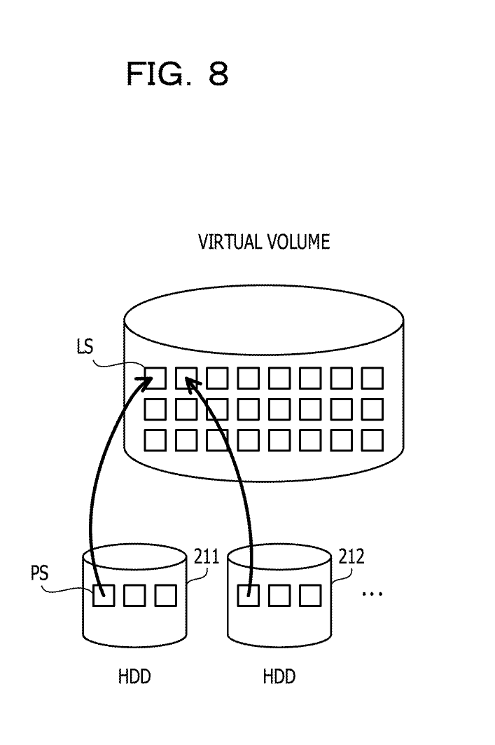

FIG. 8 is a diagram illustrating an example of a virtual volume. In the storage system of the second embodiment, physical memory areas in physical disks such as, for example, the HDDs 211 and 212 are partitioned into areas called segments in units of 1 megabyte (MB). A physical segment PS is one of the relevant segments. The virtual volume is a logical memory area to which segments are allocated by the HDDs 211, 212, . . . . Segments corresponding to the physical segments allocated to the virtual volume are each called a logical segment. A logical segment LS is a logical segment corresponding to the physical segment PS.

A method for allocating memory areas of physical memory devices to one logical volume in this way is called striping in some cases. Here, it is assumed that 1 unit obtained by collecting logical segments is called a segment group. In addition, 1 unit obtained by collecting segment groups is called a segment set.

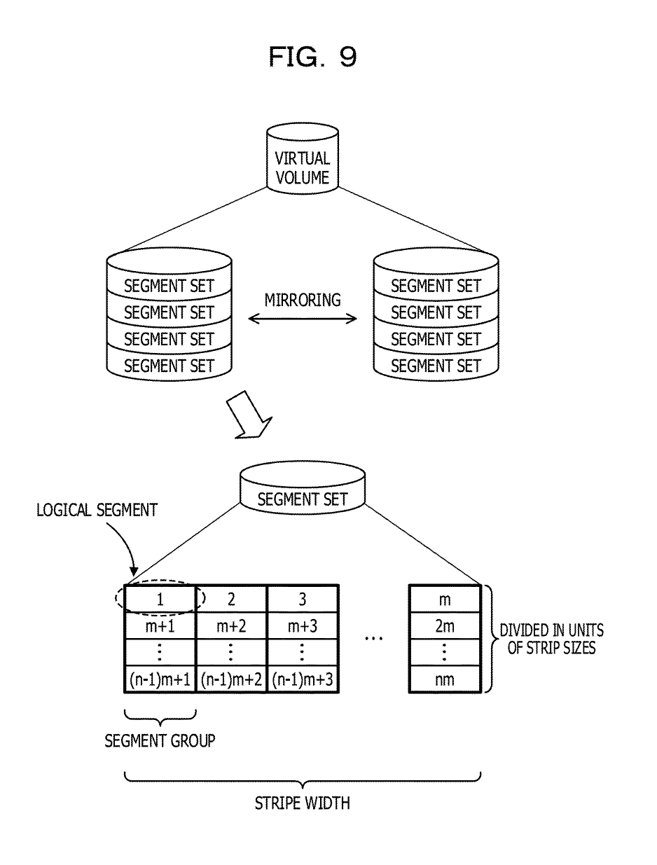

FIG. 9 is a diagram illustrating an example of allocation of logical segments to a virtual volume. The virtual volume includes segment sets. A duplicate copy of the virtual volume may be created, thereby making redundant (mirroring).

The segment sets each include “m” segment groups (“m” is an integer greater than or equal to 2). For example, one of the segment groups belongs to one of HDDs. In this case, a stripe width is “m”. In addition, the segment groups each include “n” logical segments (“n” is an integer greater than or equal to 2). If a size (strip size) of 1 logical segment (1 physical segment) is 1 MB, a size of 1 segment group is 1 MB× “n”=nMB. Then, a size of 1 segment set is nMB× “m”=nmMB.

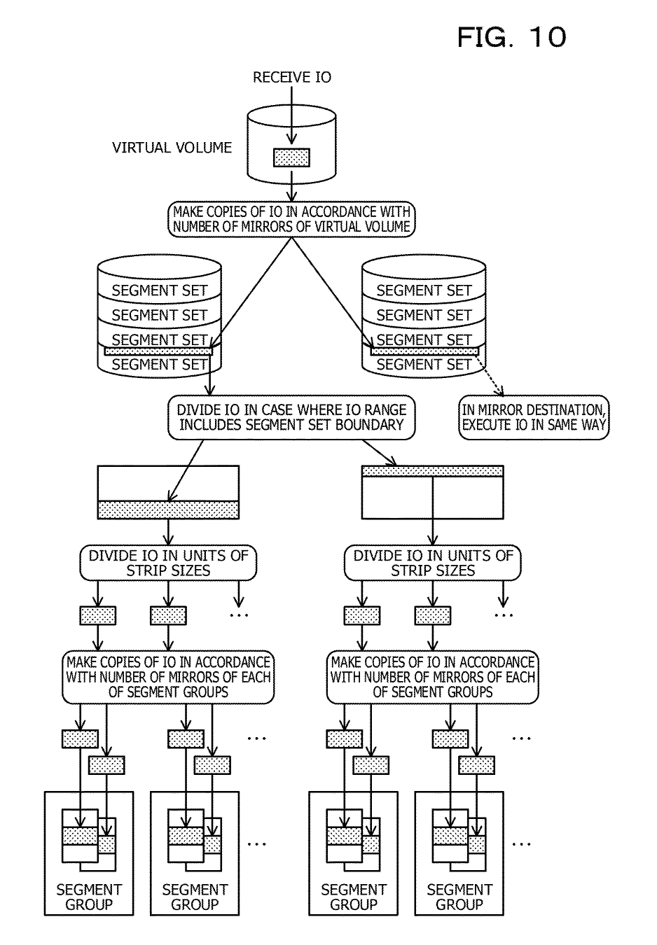

FIG. 10 is a diagram illustrating an example of IO processing performed on a virtual volume. While, in FIG. 10, as an example, processing based on the I/O processing unit 120 will be described, the other I/O processing units each perform the same processing. First, upon receiving an IO, the I/O processing unit 120 makes copies of the IO in accordance with the number of mirrors of the virtual volume (does not have to make a copy in a case of no mirroring). For one of the IOs, the I/O processing unit 120 performs the following processing. In this regard, however, the other copied IOs are processed for mirror destination volumes in the same way.

The I/O processing unit 120 identifies a segment set to which a logical address range (IO range) belongs, the logical address range (IO range) serving as an access target and being specified by the 10. In a case where the IO range includes a segment set boundary, the I/O processing unit 120 divides the 10. Here, “to divide an IO” means that, for the IO that specifies a logical address range, IOs divided for logical address ranges finer than the relevant logical address range are generated. In particular, in IO division in a case where the IO range includes a segment set boundary, a logical address range is divided at a logical address corresponding to a segment set boundary of the relevant logical address range. The logical address range is divided into 2 if there is a segment set boundary, and the logical address range turns out to be divided into 3 if there are 2 segment set boundaries. In this regard, however, if the IO range includes no segment set boundary, the IO does not have to be divided.

Regarding each one of the divided IOs, the I/O processing unit 120 further divides the relevant IO in units of strip sizes (that each correspond to the size of a logical segment and that is 1 MB according to the above-mentioned example). In accordance with the number of mirrors of each of the segment groups, the I/O processing unit 120 makes copies of the IOs divided into strip sizes. In this regard, however, in a case where no mirroring is performed in units of segment groups, the relevant copies do not have to be made. For the HDDs 211, 212, . . . , the I/O processing unit 120 executes the IOs divided into strip sizes. The I/O processing unit 120 identifies physical addresses corresponding to the respective IOs, by using the translation table. In a case where mirroring (data of one of the segment groups is copied to another one of the segment groups and is held) is performed in units of segment groups, the I/O processing unit 120 executes IOs in the same way, for the IOs copied after being divided into strip sizes.

By performing the IO division in this way, the I/O processing unit 120 executes IOs for the HDDs 211, 212, . . . . While, in the above-mentioned example, a case of performing mirroring in the layer of a virtual volume and the layer of segment groups is included and described, mirroring may be performed in only one of the layers, or mirroring in both the layers may be omitted.

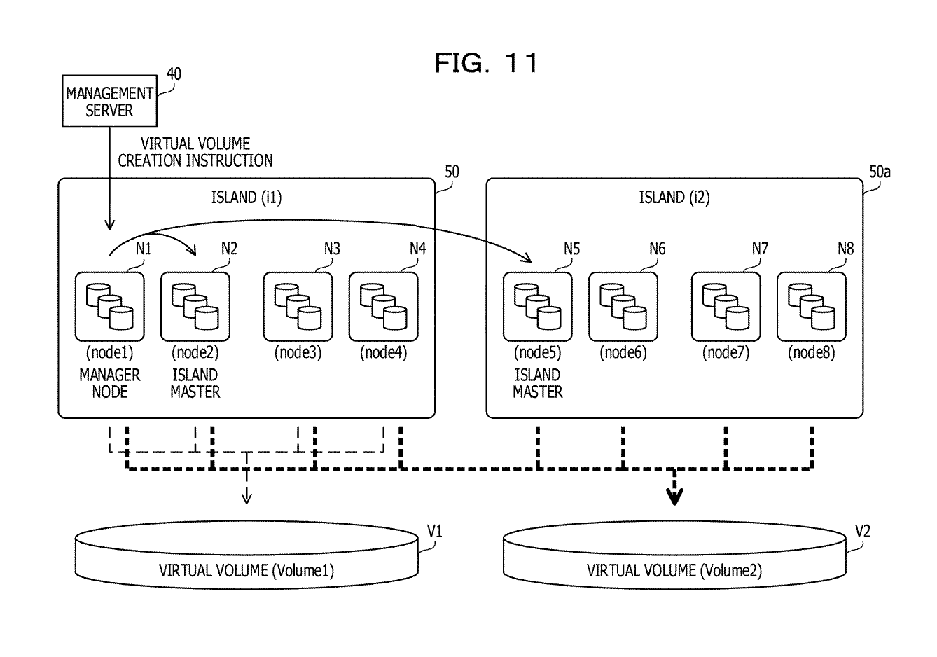

FIG. 11 is a diagram illustrating an example of creation of virtual volumes. As described above, in the storage system of the second embodiment, virtual volumes V1 independent in the respective islands 70 and 70a may be created, or a virtual volume V2 to straddle the islands 70 and 70a may be created.

Specifically, one of the virtual volumes V1 is a virtual volume created by physical segments of individual HDDs included in the nodes N1, N2, N3, and N4 (in other words, the storage units 200, 200a, 200b, and 200c) belonging to the island 70.

The virtual volume V2 is a virtual volume created by physical segments of individual HDDs included in the nodes N1, N2, N3, and N4 (in other words, the storage units 200, 200a, 200b, and 200c) belonging to the island 70 and individual HDDs included in the nodes N5, N6, N7, and N8 (in other words, the storage units 200d, 200e, 200f, and 200g) belonging to the island 70a.

Here, the management server 40 is able to issue, to the node N1 serving as the manager node, an instruction to create a virtual volume. In accordance with the instruction of the management server 40, the node N1 instructs the node N2 or node N5 serving as the island master to create a virtual volume. In accordance with the creation of the virtual volume, each of the nodes N1, N2, N3, N4, N5, N6, N7, and N8 updates management information such as a translation table, managed by the node itself.

In the management information, various kinds of information are managed while being associated with pieces of identification information of individual nodes, individual logical volumes, and so forth. In the example of the second embodiment, it is assumed that the identification information is assigned as follows.

The identification information of the island 70 is “i1”. The identification information of the island 70a is “i2”.

The identification information of the node N1 is “node1”. The identification information of the node N2 is “node2”. The identification information of the node N3 is “node3”. The identification information of the node N4 is “node4”. The identification information of the node N5 is “node5”. The identification information of the node N6 is “node6”. The identification information of the node N7 is “node7”. The identification information of the node N8 is “node8”.

The identification information of the virtual volume V1 is “Volume1”. The identification information of the virtual volume V2 is “Volume2”.

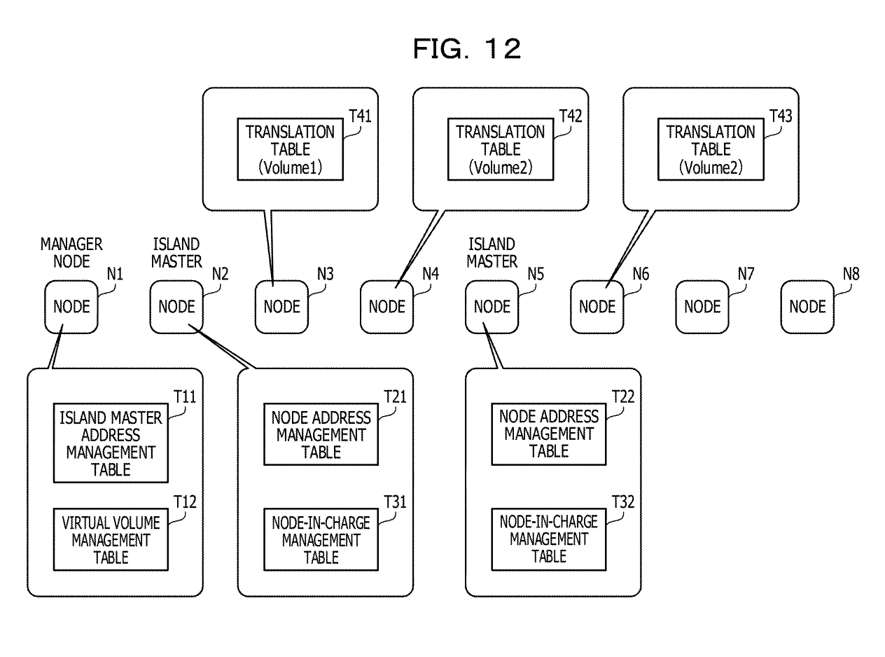

FIG. 12 is a diagram illustrating examples of tables held by individual nodes. Depending on a role of a node, a held table is different. The node N1 serving as the manager node includes an island master address management table T11 and a virtual volume management table T12.

The island master address management table T11 is a table for managing IP addresses of island masters. The virtual volume management table T12 is a table for managing a correspondence relationship between a logical address range in a virtual volume and an island in charge of the relevant logical address range.

The node N2 serving as the island master of the island 70 includes a node address management table T21 and a node-in-charge management table T31. The node address management table T21 is a table for managing IP addresses of nodes belonging to the island 70. The node-in-charge management table T31 is a table for managing a correspondence relationship between a virtual volume belonging to the island 70 and a node in charge that is in charge of accesses to the relevant virtual volume.

The node N3 in charge of accesses to the corresponding virtual volume V1 includes a translation table T41. The translation table T41 is a translation table of the corresponding virtual volume V1 (“Volume1”). Note that the translation table T41 is stored in a RAM included in the controller unit 100b and a predetermined HDD of the storage unit 200b. The translation table T41 may be stored in a RAM included in the controller unit 100c belonging to the shelf SH2 serving as the same shelf as that of the controller unit 100b and a predetermined HDD of the storage unit 200c. The reason is that even if the controller unit 100b is out of order, the controller unit 100c is able to execute an access as an alternative thereto.

The node N4 in charge of accesses to the virtual volume V2 (a portion belonging to the island 70) includes a translation table T42. The translation table T42 is a translation table (in this regard, however, a portion belonging to the island 70) of the virtual volume V2 (“Volume2”). The translation table T42 is stored in a RAM included in the controller unit 100c and a predetermined HDD of the storage unit 200c. Regarding the translation table T42, in the same way as the translation table T41, duplicate copies of the translation table T42 are arranged on the controller unit 100b and the storage unit 200b. In this regard, however, duplicate copies of the translation tables T41 and T42 are not only arranged within the same shelf SH2 but also arranged in the controller units 100, 100a, 100b, and 100c and the storage units 200, 200a, 200b, and 200c, which belong to the same island 70.

The node N5 serving as the island master of the island 70a includes a node address management table T22 and a node-in-charge management table T32. The node address management table T22 is a table for managing IP addresses of nodes belonging to the island 70a. The node-in-charge management table T32 is a table for managing a correspondence relationship between a virtual volume belonging to the island 70a and a node in charge that is in charge of accesses to the relevant virtual volume.

The node N6 in charge of accesses to the virtual volume V2 (a portion belonging to the island 70a) includes a translation table T43. The translation table T43 is a translation table (in this regard, however, a portion belonging to the island 70a) of the corresponding virtual volume V2 (“Volume2”). Note that duplicate copies of the translation table T43 may be arranged in the node N5 belonging to the same shelf SH3 or may be arranged in the individual controller units and the individual storage units of the nodes N5, N7, and N8 belonging to the same island 70a.

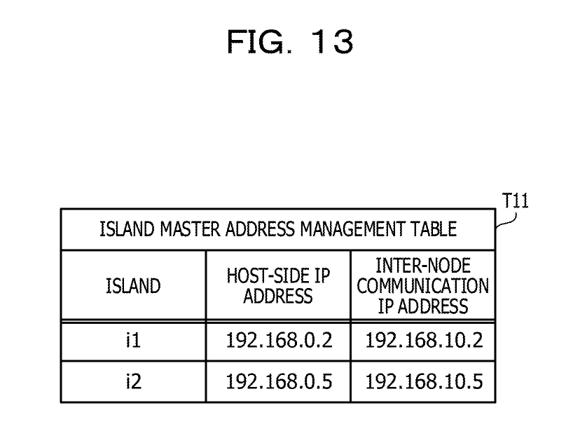

FIG. 13 is a diagram illustrating an example of an island master address management table. The island master address management table T11 is stored in the memory unit 110. The island master address management table T11 includes items of an island, a host-side IP address, and an inter-node communication IP address.

In the item of the island, identification information of an island is registered. In the item of the host-side IP address, an IP address used for communication on a SAN 50 (IP-SAN) side is registered. In the item of the inter-node communication IP address, an IP address used for communication on a LAN 60 side is registered.

In, for example, the island master address management table T11, information that the island is “i1”, the host-side IP address is “192.168.0.2”, and the inter-node communication IP address is “192.168.10.2” is registered. This indicates that a SAN 50-side communication IP address of the node N2 serving as the island master of the island 70 corresponding to the identification information “i1” is “192.168.0.2” and a LAN 60-side communication IP address thereof is “192.168.10.2”. Note that it is assumed that a subnet mask of each of the IP addresses is “/24” (the same shall apply hereinafter).

In addition, in the island master address management table T11, information that the island is “i2”, the host-side IP address is “192.168.0.5”, and the inter-node communication IP address is “192.168.10.5” is registered. This indicates that a SAN 50-side communication IP address of the node N5 serving as the island master of the island 70a corresponding to the identification information “i2” is “192.168.0.5” and a LAN 60-side communication IP address thereof is “192.168.10.5”.

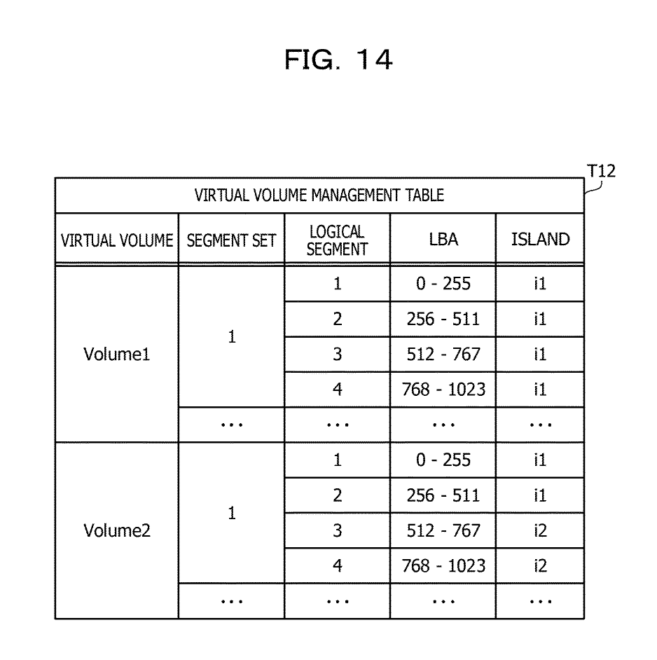

FIG. 14 is a diagram illustrating an example of a virtual volume management table. The virtual volume management table T12 is stored in the memory unit 110. The virtual volume management table T12 includes items of a virtual volume, a segment set, a logical segment, an LBA, and an island.

In the item of the virtual volume, identification information of a virtual volume is registered. In the item of the segment set, the identification number of a segment set is registered. In the item of the logical segment, the identification number of a logical segment in the relevant segment set in the virtual volume is registered. In the item of the LBA, the range of an LBA corresponding to each of logical segments in the virtual volume is registered. In the item of the island, identification information of an island is registered.

In, for example, the virtual volume management table T12, information that the virtual volume is “Volume12”, the segment set is “1”, the logical segment is “1”, the LBA is “0-255”, and the island is “i1” is registered. This indicates that a logical segment of an identification number “1” included in the segment set of the identification number “1” of the corresponding virtual volume V1 (“Volume1”) corresponds to an LBA range from “0” to “255” and the relevant LBA range belongs to the island 70 (“i1”).

Since, according to the virtual volume management table T12, the corresponding virtual volume V1 is created by HDDs of the island 70, each of LBA ranges belongs to the island 70. On the other hand, since the virtual volume V2 (“Volume2”) is created by HDDs of the islands 70 and 70a, some of LBA ranges belong to the island 70, and some other LBA range belong to the island 70a.

For example, the LBA range “0-255” corresponding to the logical segment of the identification number “1” in the segment set of the identification number “1” of the virtual volume V2 and an LBA range “256-511” corresponding to a logical segment of an identification number “2” thereof belong to the island 70 (“i1”).

On the other hand, an LBA range “512-767” corresponding to a logical segment of an identification number “3” in the segment set of the identification number “1” of the virtual volume V2 and an LBA range “768-1023” corresponding to a logical segment of an identification number “4” thereof belong to the island 70a (“i2”).

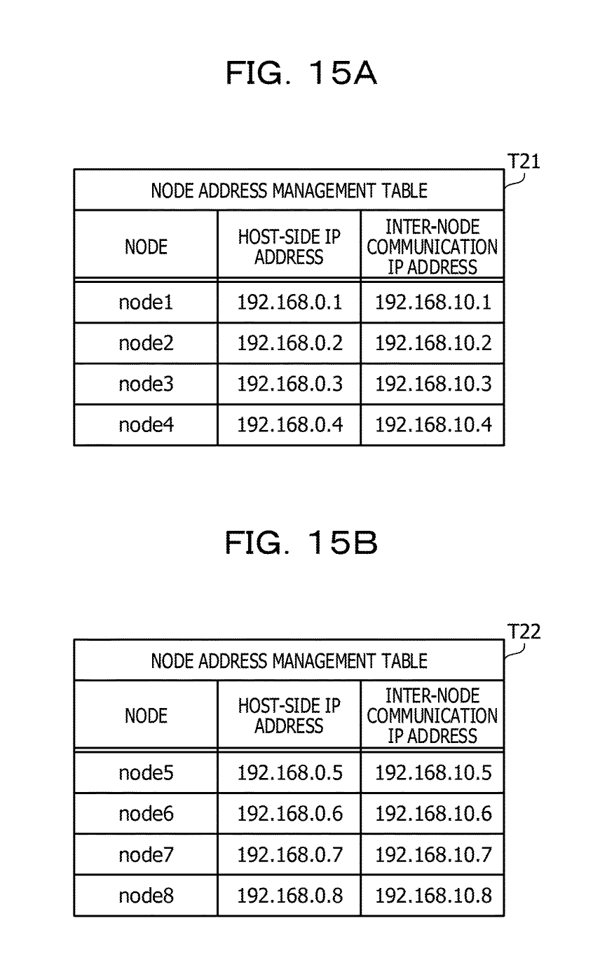

FIGS. 15A and 15B are diagrams each illustrating an example of a node address management table. FIG. 15A exemplifies the node address management table T21. The node address management table T21 is stored in the memory unit 110a. FIG. 15B exemplifies the node address management table T22. The node address management table T22 is stored in a memory unit included in the node N5. The node address management tables T21 and T22 each include items of a node, a host-side IP address, and an inter-node communication IP address.

In the item of the node, a node identifier (ID) is registered. In the item of the host-side IP address, an IP address used for communication on a SAN 50 (IP-SAN) side is registered. In the item of the inter-node communication IP address, an IP address used for communication on a LAN 60 side is registered.

In, for example, the node address management table T21, information that the node is “node1”, the host-side IP address is “192.168.0.1”, and the inter-node communication IP address is “192.168.10.1” is registered. This indicates that a SAN 50-side communication IP address of the node N1 corresponding to the node ID “node1” is “192.168.0.1” and a LAN 60-side communication IP address thereof is “192.168.10.1”. Since the node address management table T21 is information for managing addresses of nodes within the island 70, address information related to the nodes N1, N2, N3, and N4 is registered.

In addition, in, for example, the node address management table T22, information that the node is “node5”, the host-side IP address is “192.168.0.5”, and the inter-node communication IP address is “192.168.10.5” is registered. This indicates that a SAN 50-side communication IP address of the node N5 corresponding to the node ID “node5” is “192.168.0.5” and a LAN 60-side communication IP address thereof is “192.168.10.5”. Since the node address management table T22 is information for managing addresses of nodes within the island 70a, address information related to the nodes N5, N6, N7, and N8 is registered.

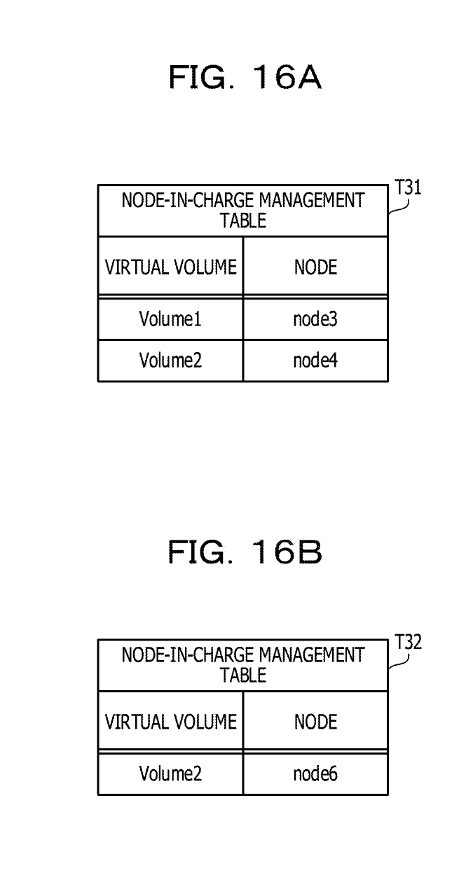

FIGS. 16A and 16B are diagrams each illustrating an example of a node-in-charge management table. FIG. 16A exemplifies the node-in-charge management table T31. The node-in-charge management table T31 is stored in the memory unit 110a. FIG. 16B exemplifies the node-in-charge management table T32. The node-in-charge management table T32 is stored in a memory unit included in the node N5. The node-in-charge management tables T31 and T32 each include items of a virtual volume and a node.

In the item of the virtual volume, identification information of a virtual volume is registered. In the item of the node, a node ID is registered.

In, for example, the node-in-charge management table T31, information that the virtual volume is “Volume1” and the node is “node3” is registered. This indicates that a node in charge that is in charge of accesses to the virtual volume V1 (“Volume1”) is the node N3 (“node3”).

In addition, in, for example, the node-in-charge management table T31, information that the virtual volume is “Volume2” and the node is “node4” is registered. This indicates that a node in charge that is in charge of accesses to the virtual volume V2 (“Volume2”) (in this regard, however, a portion belonging to the island 70) is the node N4 (“node4”).

Furthermore, in, for example, the node-in-charge management table T32, information that the virtual volume is “Volume2” and the node is “node6” is registered. This indicates that a node in charge that is in charge of accesses to the virtual volume V2 (“Volume2”) (in this regard, however, a portion belonging to the island 70a) is the node N6 (“node6”).

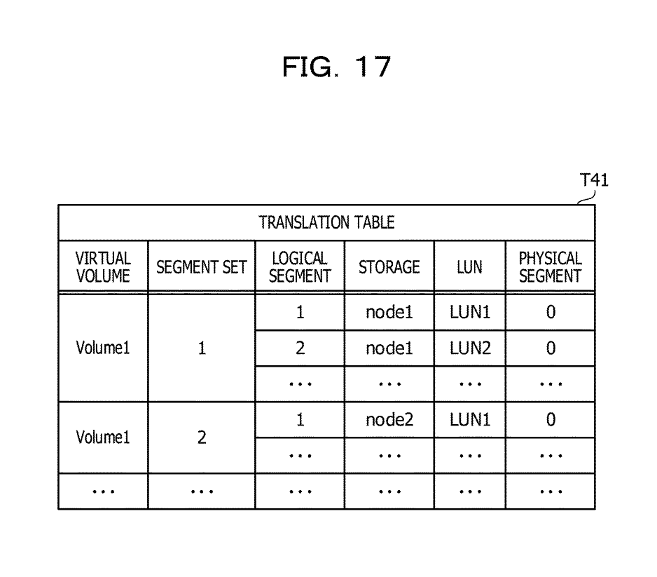

FIG. 17 is a diagram illustrating an example of a translation table (part one). The translation table T41 is stored in the memory unit 110b. The translation table T41 is a table for translation between an LBA and a physical address in the virtual volume V1. The translation table T41 includes items of a virtual volume, a segment set, a logical segment, a storage, a logical unit number (LUN), and a physical segment.

In the item of the virtual volume, identification information of a virtual volume is registered. In the item of the segment set, the identification number of a segment set is registered. In the item of the logical segment, the identification number of a logical segment is registered. In the item of the storage, a node ID of a node including an HDD including a physical segment corresponding to the corresponding logical segment is registered. In the item of the LUN, a LUN in the relevant node is registered. In the item of the physical segment, the identification number of a physical segment is registered.

In, for example, the translation table T41, information that the virtual volume is “Volume1”, the segment set is “1”, the logical segment is “1”, the storage is “node1”, the LUN is “LUN1”, and the physical segment is “0” is registered. This indicates that the logical segment (LBA range “0-255”) of the identification number “1” of the segment set of the identification number “1” of the virtual volume V1 (“Volume1”) corresponds to a physical segment of the identification number “0” of the LUN “LUN1” of the node N1 (“node1”).

In addition, in, for example, the translation table T41, information that the virtual volume is “Volume1”, the segment set is “1”, the logical segment is “2”, the storage is “node1”, the LUN is “LUN2”, and the physical segment is “0” is registered. This indicates that the logical segment (LBA range “256-511”) of the identification number “2” of the segment set of the identification number “1” of the virtual volume V1 (“Volume1”) corresponds to the physical segment of the identification number “0” of the LUN “LUN2” of the node N1 (“node1”).

In this way, in the translation table T41, physical segments within the HDDs included in the nodes N1, N2, N3, and N4 are associated with respective logical segments (LBA ranges) of the virtual volume V1.

Here, association information between, for example, the identification numbers of physical segments, individual HDDs, and physical addresses on the HDDs is preliminarily held by each of the controller units. Therefore, if the identification number of a physical segment becomes clear, each of the controller unit is able to access the corresponding physical segment, based on the relevant association information. In that case, each of the controller units is able to translate a specified LBA range of a virtual volume to a physical address range on a physical segment.

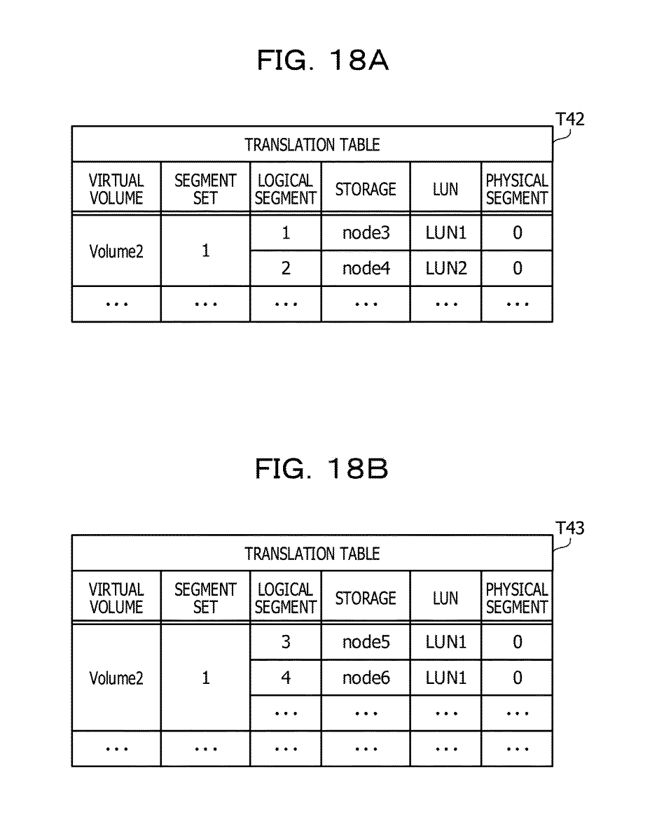

FIGS. 18A and 18B are diagrams each illustrating an example of a translation table (part two). FIG. 18A exemplifies the translation table T42. The translation table T42 is stored in a memory unit included in the node N4. FIG. 18B exemplifies the translation table T43. The translation table T43 is stored in a memory unit included in the node N6. Each of the translation tables T42 and T43 is a table for translation between an LBA and a physical address in the virtual volume V2. The translation table T42 and T43 each include items of a virtual volume, a segment set, a logical segment, a storage, a LUN, and a physical segment. Here, pieces of information registered in respective items of each of the translation tables T42 and T43 are the same as pieces of information registered in respective items that have the same names and that are included in the translation table T41.

In, for example, the translation table T42, information that the virtual volume is “Volume2”, the segment set is “1”, the logical segment is “1”, the storage is “node3”, the LUN is “LUN1”, and the physical segment is “0” is registered. This indicates that the logical segment (LBA range “0-255”) of the identification number “1” of the segment set of the identification number “1” of the virtual volume V2 (“Volume2”) corresponds to a physical segment of the identification number “0” of the LUN “LUN1” of the node N3 (“node3”).

In the translation table T42, information that the virtual volume is “Volume2”, the segment set is “1”, the logical segment is “2”, the storage is “node4”, the LUN is “LUN2”, and the physical segment is “0” is registered. This indicates that the logical segment (LBA range “256-511”) of the identification number “2” of the segment set of the identification number “1” of the virtual volume V2 (“Volume2”) corresponds to a physical segment of the identification number “0” of the LUN (“LUN2”) of the node N4 (“node4”).

In addition, in, for example, the translation table T43, information that the virtual volume is “Volume2”, the segment set is “1”, the logical segment is “3”, the storage is “node5”, the LUN is “LUN1”, and the physical segment is “0” is registered. This indicates that the logical segment (LBA range “512-767”) of the identification number “3” of the segment set of the identification number “1” of the virtual volume V2 (“Volume2”) corresponds to a physical segment of the identification number “0” of the LUN “LUN1” of the node N5 (“nodes”).

In the translation table T43, information that the virtual volume is “Volume2”, the segment set is “1”, the logical segment is “4”, the storage is “node6”, the LUN is “LUN1”, and the physical segment is “0” is registered. This indicates that the logical segment (LBA range “768-1023”) of the identification number “4” of the segment set of the identification number “1” of the virtual volume V2 (“Volume2”) corresponds to a physical segment of the identification number “0” of the LUN “LUN1” of the node N6 (“node6”).

In this way, the virtual volume V2 is created so as to straddle the islands 70 and 70a. Therefore, regarding a translation table, a translation table (the translation table T42) of which the island 70 is in charge and a translation table (the translation table T43) of which the island 70a is in charge are separately created.

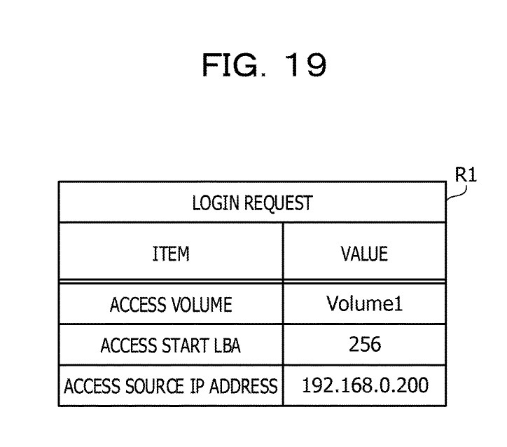

FIG. 19 is a diagram illustrating an example of information included in a login request. A login request R1 includes items and values corresponding to the respective items. The login request R1 includes items of, for example, an access volume, an access start LBA, and an access source IP address.

The access volume is identification information of a virtual volume serving as an access destination. The access start LBA is an LBA from which an access to the relevant virtual volume is started. The access source IP address is an IP address of an issuing source device of the login request R1.

The login request R1 includes, for example, information that the access volume is “Volume1”, the access start LBA is “256”, and the access source IP address is “192.168.0.200”. This indicates that the login request R1 is a login request for performing an access to begin at an LBA “256” of the virtual volume V1 (“Volume1”) and the IP address of an access source device is “192.168.0.200”. Note that the IP address “192.168.0.200” is the IP address of the business server 30.

Here, it may be said that the login request R1 is a request to couple to a virtual volume, the request being transmitted to the node N1 serving as the manager node by the access source device (the business server 30 in some cases or one of nodes of a storage system in other cases).

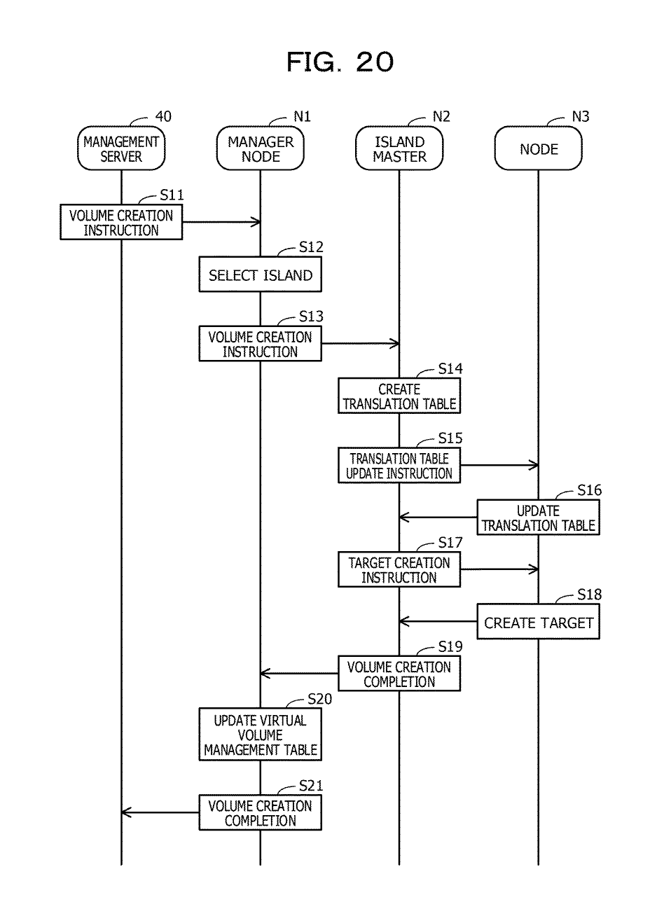

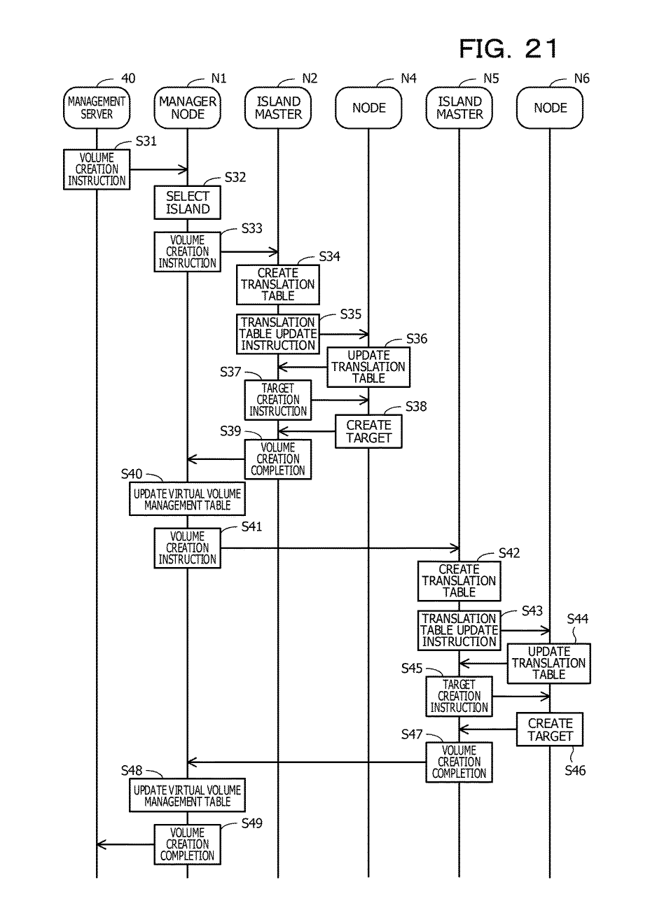

Hereinafter, a processing procedure in the storage system of the second embodiment will be described. First, a creation procedure of a virtual volume will be described. A method for creating the virtual volume has 2 patterns. The first pattern corresponds to a case where one virtual volume V1 is created within one island (FIG. 20). The second pattern corresponds to a case where one virtual volume V2 is created so as to straddle 2 islands (FIG. 21).

FIG. 20 is a diagram illustrating an example of a first sequence of virtual volume creation. Hereinafter, processing illustrated in FIG. 20 will be described in line with step numbers. Note that, in the following description, in order to easily understand that the node N1 is a manager node and the node N2 is an island master, the node N1 and the N2 are specified as the manager node N1 and the island master N2, respectively.

(S11) The management server 40 transmits, to the manager node N1, an instruction to create the virtual volume V1 (a volume creation instruction). The volume creation instruction includes the size of the virtual volume V1 to be newly created. The volume creation instruction may include specifications of the presence or absence of mirroring, a stripe width, and so forth in the virtual volume V1. In addition, the volume creation instruction may include information for specifying an island in which the virtual volume V1 is to be created. The manager node N1 receives the volume creation instruction from the management server 40.

(S12) In accordance with the volume creation instruction, the manager node N1 selects an island in which the virtual volume V1 is to be newly created. It may be considered that the manager node N1 selects, as a creation destination of the virtual volume, an island having, as a virtual volume, the lowest usage rate at the present moment, for example. Alternatively, in a case where the volume creation instruction includes information for specifying an island to serve as a creation destination, the manager node N1 may select, as the creation destination of the virtual volume V1, an island specified by the volume creation instruction. The manager node N1 selects the island 70 as the creation destination of the virtual volume V1.

(S13) The manager node N1 transmits an instruction to create the virtual volume V1 (a volume creation instruction), to the island master N2 of the island 70 selected in step S12. Here, the manager node N1 acquires, from the island master address management table T11, the IP address of the island master N2 (a destination IP address of the volume creation instruction). The island master N2 receives the volume creation instruction from the manager node N1.

(S14) The island master N2 allocates, to the virtual volume V1, physical segments of individual HDDs included in the storage units 200, 200a, 200b, and 200c. Based on an allocation result, the island master N2 creates the translation table T41.

(S15) The island master N2 determines the node N3 as a node in charge of the virtual volume V1. It may be considered that the island master N2 defines, as the node in charge of the virtual volume V1, for example, a node in which the number of virtual volumes is the lowest, the relevant node being in charge of accesses to the virtual volumes. Alternatively, by using round-robin, the island master N2 may sequentially allocate nodes in charge to virtual volumes. The island master N2 transmits, to the node N3, a translation table update instruction for instructing to update a translation table. The translation table update instruction includes the translation table T41 created in step S14. The node N3 receives the translation table update instruction from the island master N2.

(S16) The node N3 registers, in the memory unit 110b, the translation table T41 received from the island master N2 (translation table update). The node N3 transmits, to the island master N2, a completion notice of the translation table update. The island master N2 receives, from the node N3, the completion notice of the translation table update.

(S17) The island master N2 transmits, to the node N3, an instruction to create an iSCSI target (simply called a target). The node N3 receives, from the island master N2, the instruction to create a target.

(S18) By controlling the nodes N1, N2, N3, and N4 belonging to the island 70, the node N3 creates a target corresponding to the virtual volume V1. The node N3 transmits, to the island master N2, a completion notice of the target creation. The island master N2 receives, from the node N3, the completion notice of the target creation.

(S19) The island master N2 transmits, to the manager node N1, a volume creation completion notice indicating that creation of the virtual volume V1 is completed. The manager node N1 receives the volume creation completion notice from the island master N2.

(S20) The manager node N1 registers, in the virtual volume management table T12, information related to the newly created virtual volume V1 (the virtual volume management table T12 is updated).

(S21) The manager node N1 transmits a volume creation completion notice to the management server 40. The management server 40 receives the volume creation completion notice from the manager node N1. In this way, it becomes possible for the business server 30 to mount and use a memory device corresponding to the virtual volume V1.

FIG. 21 is a diagram illustrating an example of a second sequence of virtual volume creation. Hereinafter, processing illustrated in FIG. 21 will be described in line with step numbers.

(S31) The management server 40 transmits, to the manager node N1, an instruction to create the virtual volume V2 (a volume creation instruction). The volume creation instruction includes the size of the virtual volume V2 to be newly created. The volume creation instruction may include specifications of the presence or absence of mirroring, a stripe width, and so forth in the virtual volume V2. In addition, the volume creation instruction may include information for specifying a group of islands in which the virtual volume V2 is to be created. The manager node N1 receives the volume creation instruction from the management server 40.

(S32) In accordance with the volume creation instruction, the manager node N1 selects islands in which the virtual volume V2 is to be newly created. In a case where it is difficult for an island having the lowest usage rate to single-handedly realize a requested volume size, it may be considered that the manager node N1 selects, as creation destinations of the virtual volume V2, an island having the lowest usage rate and an island having the second lowest usage rate, for example. Alternatively, in a case where the volume creation instruction includes information for specifying a group of islands to serve as creation destinations, the manager node N1 may select, as the creation destinations of the virtual volume V2, the group of islands specified by the volume creation instruction. The manager node N1 selects the islands 70 and 70a as the creation destinations of the virtual volume V2.

(S33) The manager node N1 transmits, to the island master N2 of the island 70 selected in step S32, an instruction to create a first portion (a portion belonging to the island 70) of the virtual volume V2 (a volume creation instruction). Here, the manager node N1 acquires, from the island master address management table T11, the IP address of the island master N2 (a destination IP address of the volume creation instruction). The island master N2 receives the volume creation instruction from the manager node N1.

(S34) The island master N2 allocates, to the first portion of the virtual volume V2, physical segments of individual HDDs included in the storage units 200, 200a, 200b, and 200c. Based on an allocation result, the island master N2 creates the translation table T42.

(S35) The island master N2 determines the node N4 as a node in charge of the first portion of the virtual volume V2. A method for determining the node in charge is the same as the method exemplified in step S15 in FIG. 20. The island master N2 transmits, to the node N4, a translation table update instruction for instructing to update a translation table. The translation table update instruction includes the translation table T42 created in step S34. The node N4 receives the translation table update instruction from the island master N2.

(S36) The node N4 registers, in a memory unit included in the node N4, the translation table T42 received from the island master N2 (translation table update). The node N4 transmits, to the island master N2, a completion notice of the translation table update. The island master N2 receives, from the node N4, the completion notice of the translation table update.

(S37) The island master N2 transmits, to the node N4, an instruction to create a target. The node N4 receives, from the island master N2, the instruction to create a target.

(S38) By controlling the nodes N1, N2, N3, and N4 belonging to the island 70, the node N4 creates a target corresponding to the first portion of the virtual volume V2. The node N4 transmits, to the island master N2, a completion notice of the target creation. The island master N2 receives, from the node N4, the completion notice of the target creation.

(S39) The island master N2 transmits, to the manager node N1, a volume creation completion notice indicating that creation of the first portion of the virtual volume V2 is completed. The manager node N1 receives the volume creation completion notice from the island master N2.

(S40) The manager node N1 registers, in the virtual volume management table T12, information related to the first portion of the newly created virtual volume V2 (the virtual volume management table T12 is updated).

(S41) The manager node N1 transmits, to the island master N5 in the island 70a selected in step S32, an instruction to create a second portion (a portion belonging to the island 70a) of the virtual volume V2 (a volume creation instruction). Here, the manager node N1 acquires, from the island master address management table T11, an IP address of the island master N5 (a destination IP address of the volume creation instruction). The island master N5 receives the volume creation instruction from the manager node N1.

(S42) The island master N5 allocates, to the second portion of the virtual volume V2, physical segments of individual HDDs included in the storage units 200d, 200e, 200f, and 200g. Based on an allocation result, the island master N5 creates the translation table T43.

(S43) The island master N5 determines the node N6 as a node in charge of the second portion of the virtual volume V2. A method for determining the node in charge is the same as the method exemplified in step S15 in FIG. 20. The island master N5 transmits, to the node N6, a translation table update instruction for instructing to update a translation table. The translation table update instruction includes the translation table T43 created in step S42. The node N6 receives the translation table update instruction from the island master N5.

(S44) The node N6 registers, in a memory unit included in the node N6, the translation table T43 received from the island master N5 (translation table update). The node N6 transmits, to the island master N5, a completion notice of the translation table update. The island master N5 receives, from the node N6, the completion notice of the translation table update.

(S45) The island master N5 transmits, to the node N6, an instruction to create a target. The node N6 receives, from the island master N5, the instruction to create a target.

(S46) By controlling the nodes N5, N6, N7, and N8 belonging to the island 70a, the node N6 creates a target corresponding to the second portion of the virtual volume V2. The node N6 transmits, to the island master N5, a completion notice of the target creation. The island master N5 receives, from the node N6, the completion notice of the target creation.

(S47) The island master N5 transmits, to the manager node N1, a volume creation completion notice indicating that creation of the second portion of the virtual volume V2 is completed. The manager node N1 receives the volume creation completion notice from the island master N5.

(S48) The manager node N1 registers, in the virtual volume management table T12, information related to the second portion of the newly created virtual volume V2 (the virtual volume management table T12 is updated).

(S49) The manager node N1 transmits a volume creation completion notice to the management server 40. The management server 40 receives the volume creation completion notice from the manager node N1. In this way, it becomes possible for the business server 30 to mount and use a memory device corresponding to the virtual volume V2.

Here, the processing based on the manager node N1 in each of FIGS. 20 and 21 is performed by the manager processing unit 130. In addition, the processing based on the island node N3 in each of FIGS. 20 and 21 is performed by the master processing unit 140. Furthermore, the processing based on the island node N5 in FIG. 21 is performed by a master processing unit included in the controller unit 100d. It may be considered that processing operations other than those are performed by I/O processing units in respective controller units.

Note that while, in the example of FIG. 21, a method for creating the virtual volume V2 to straddle 2 islands is exemplified, a virtual volume to straddle 3 or more islands may be created by using the same method in a case of creating the virtual volume. Specifically, in step S32, the manager node N1 selects 3 or more islands. In addition, after step S48 and before step S49, the manager node N1 further transmits a volume creation instruction to another island master and causes the other island master to create a target corresponding to a remaining portion of the virtual volume.

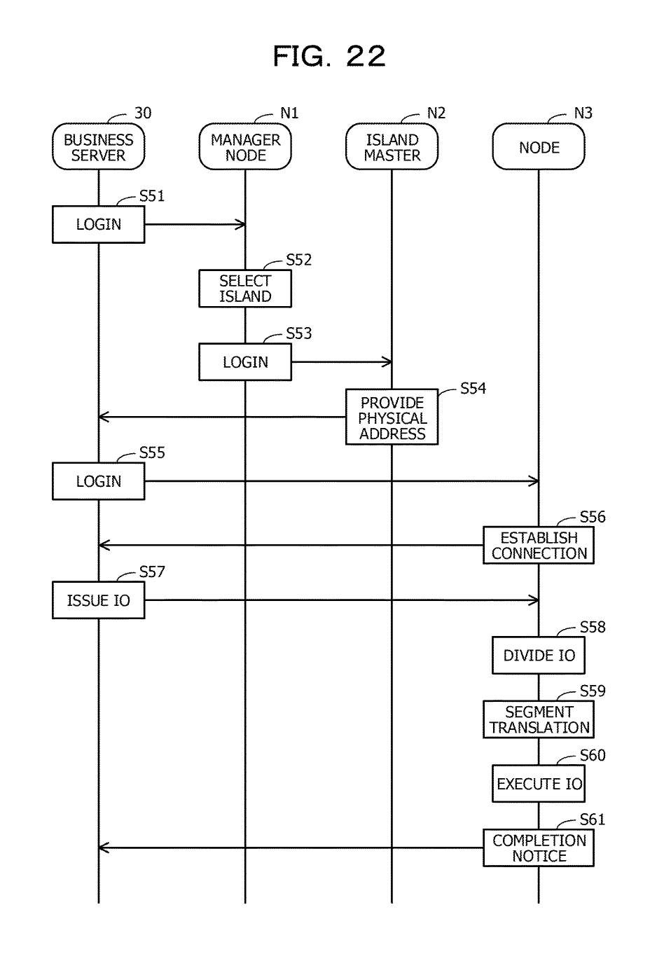

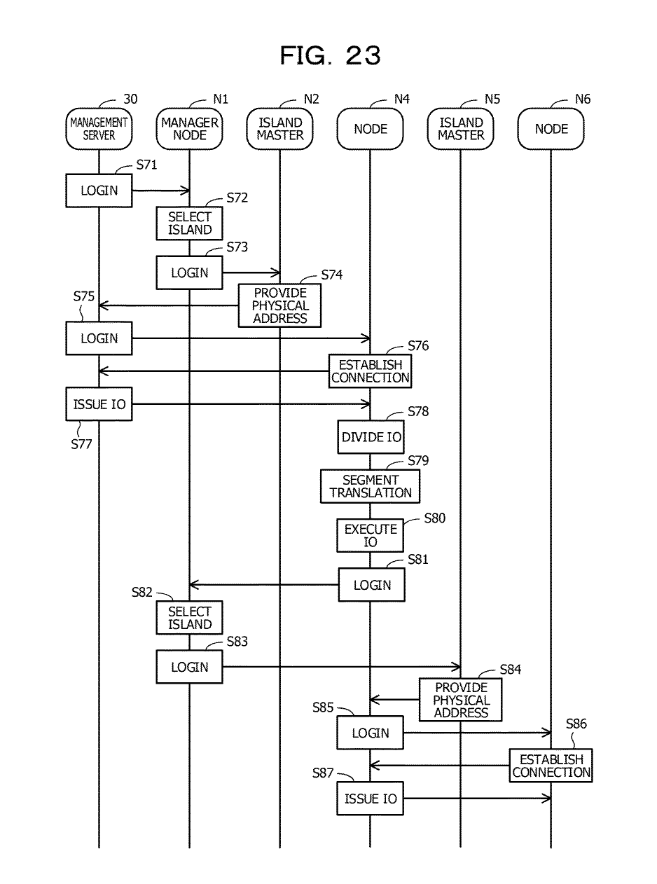

Next, a procedure of I/O processing for a virtual volume will be described. A method for the I/O processing has 2 patterns. The first pattern corresponds to a case where an IO falls within one island (FIG. 22). The second pattern corresponds to a case where an IO straddles 2 or more islands (FIGS. 23 to 26).

FIG. 22 is a diagram illustrating an example of a first sequence of I/O processing. Hereinafter, processing illustrated in FIG. 22 will be described in line with step numbers.

(S51) The business server 30 transmits a login request to the manager node N1. It is assumed that the login request includes, for example, the virtual volume V1 to serve as an access destination, an LBA of the virtual volume V1, from which an access is to be started, and an IP address of the business server 30. The manager node N1 receives the login request from the business server 30.

(S52) Based on information included in the login request received in step S51 and the virtual volume management table T12, the manager node N1 selects an island. In a case where, in the login request, for example, the virtual volume V1 and an LBA “256” from which an access is to be started are specified, the island 70 (the identification information “i1”) turns out to be selected according to the virtual volume management table T12. By referencing the island master address management table T11, the manager node N1 acquires an IP address of the island master N2 of the island 70 (a transfer destination address of the login request).

(S53) The manager node N1 transfers the login request to the island master N2. The island master N2 receives the login request transferred by the manager node N1.

(S54) By referencing the node-in-charge management table T31, the island master N2 identifies that a node in charge of the virtual volume V1 to serve as an access destination included in the login request is the node N3. By referencing the node address management table T21, the island master N2 acquires an IP address of the node N3. The island master N2 transmits the IP address of the node N3 while addressing to the IP address of the business server 30, included in the login request (provision of a physical address to the business server 30). The business server 30 receives the IP address of the node N3 from the island master N2. In this way, the business server 30 resolves an IP address (the IP address of the node N3) of an establishment destination of a connection for accessing the virtual volume V1.

(S55) The business server 30 transmits, to the node N3, a predetermined login request according to a protocol of the iSCSI. The node N3 receives the login request from the business server 30.

(S56) Upon succeeding in authentication based on the login request received in step S55, the node N3 establishes a connection with the business server 30.

(S57) The business server 30 issues, to the node N3, an IO request for the virtual volume V1. The IO request may include, for example, information of the virtual volume V1, an LBA range of an access destination in the virtual volume V1, and so forth.

(S58) Based on the translation table T41, the node N3 divides an IO in units of logical segments. A specific method is as exemplified in FIG. 10. Here, the node N3 holds information of a correspondence relationship between the LBA range in the virtual volume V1 and logical segments, and by the LBA range of the access destination being specified, the node N3 is able to divide the IO in units of logical segments. In this regard, however, in a case where the LBA range of the access destination falls within one logical segment, the IO does not have to be divided (the same applies to the following processing).

(S59) Based on the translation table T41, the node N3 translates IOs in units of logical segments to IOs in units of physical segments (access destinations of the IOs are translated to physical addresses on individual HDDs).

(S60) By controlling the nodes N1, N2, N3, and N4, the node N3 executes the IO. If the IO is, for example, reading of data, reading of the corresponding data is performed. In addition, if the IO is, for example, writing of data, writing of the corresponding data is performed.

(S61) The node N3 transmits a completion notice of the IO to the business server 30. In a case of reading of data, the completion notice includes the read data. In addition, in a case where the IO is writing of data, the completion notice includes a notice of completion of writing. The business server 30 receives the completion notice from the node N3.

FIG. 23 is a diagram illustrating an example of a second sequence of I/O processing. Hereinafter, processing illustrated in FIG. 23 will be described in line with step numbers.

(S71) The business server 30 transmits a login request to the manager node N1. It is assumed that the login request includes, for example, the virtual volume V2 to serve as an access destination, an LBA of the virtual volume V2, from which an access is to be started, and the IP address of the business server 30. The manager node N1 receives the login request from the business server 30.

(S72) Based on information included in the login request received in step S71 and the virtual volume management table T12, the manager node N1 selects an island. In a case where, in the login request, for example, the virtual volume V2 and an LBA “256” from which an access is to be started are specified, the island 70 (the identification information “i1”) turns out to be selected according to the virtual volume management table T12. By referencing the island master address management table T11, the manager node N1 acquires the IP address of the island master N2 of the island 70 (a transfer destination address of the login request).

(S73) The manager node N1 transfers the login request to the island master N2. The island master N2 receives the login request transferred by the manager node N1.

(S74) By referencing the node-in-charge management table T31, the island master N2 identifies that a node in charge of the virtual volume V2 to serve as an access destination included in the login request is the node N4. By referencing the node address management table T21, the island master N2 acquires an IP address of the node N4. The island master N2 transmits the IP address of the node N4 while addressing to the IP address of the business server 30, included in the login request (provision of a physical address to the business server 30). The business server 30 receives the IP address of the node N4 from the island master N2. In this way, the business server 30 resolves an IP address (the IP address of the node N4) of an establishment destination of a connection for accessing the virtual volume V2.

(S75) The business server 30 transmits, to the node N4, a predetermined login request according to a protocol of the iSCSI. The node N4 receives the login request from the business server 30. For the node N4 serving as a target, the business server 30 functions as an initiator.

(S76) Upon succeeding in authentication based on the login request received in step S75, the node N4 establishes a connection with the business server 30.

(S77) The business server 30 issues, to the node N4, an IO request for the virtual volume V2. The IO request may include, for example, information of the virtual volume V2, an LBA range of an access destination in the virtual volume V2, and so forth.

(S78) Based on the translation table T42, the node N4 divides an IO in units of logical segments. A specific method is as exemplified in FIG. 10. Here, the node N4 holds a correspondence relationship between the LBA range in the first portion (a portion belonging to the island 70) of the virtual volume V2 and logical segments, and by the LBA range of the access destination being specified, the node N4 is able to divide the IO in units of logical segments. In this regard, however, regarding the node N4, it is difficult for the node N4 to process an LBA range in the second portion (a portion belonging to the island 70a) of the virtual volume V2 (the second portion of the virtual volume is not processed in step S79 or S80). Specifically, it is assumed that an IO from the business server 30 specifies the LBA range “256-767” of the virtual volume V2. In this case where, while it is possible for the node N4 to process the LBA range “256-511” (the first portion, which corresponds to the segment set “1” and the logical segment “2” of the virtual volume V2), it is difficult for the node N4 to process the LBA range “512-767” (the second portion, which corresponds to the segment set “1” and the logical segment “3” of the virtual volume V2).

(S79) Based on the translation table T42, the node N4 translates IOs in units of logical segments to IOs in units of physical segments (access destinations of the IOs are translated to physical addresses on individual HDDs).

(S80) By controlling the nodes N1, N2, N3, and N4, the node N4 executes the IO. If the IO is, for example, reading of data, reading of the corresponding data is performed. In addition, if the IO is, for example, writing of data, writing of the corresponding data is performed. Since the IO requested by the business server 30 has an unexecuted portion, the node N4 holds an IO result (an access result) in a memory device such as a RAM.

(S81) In order to perform an IO on an unaccessed portion of the virtual volume V2, the node N4 transmits a login request to the manager node N1. The relevant login request includes, for example, the virtual volume V2 serving as a virtual volume of an access destination, an access start LBA in an LBA range of the virtual volume V2 corresponding to the unaccessed portion, and the IP address of the node N4 serving as a transmission source IP address. The manager node N1 receives the login request from the node N4.

(S82) Based on information included in the login request received in step S81 and the virtual volume management table T12, the manager node N1 selects an island. In a case where, in the login request, for example, the virtual volume V2 and an LBA “512” from which an access is to be started are specified, the island 70a (the identification information “i2”) turns out to be selected according to the virtual volume management table T12. By referencing the island master address management table T11, the manager node N1 acquires the IP address of the island master N5 of the island 70a (a transfer destination address of the login request).

(S83) The manager node N1 transfers the login request to the island master N5. The island master N5 receives the login request transferred by the manager node N1.

(S84) By referencing the node-in-charge management table T32, the island master N5 identifies that a node in charge of the virtual volume V2 to serve as an access destination included in the login request is the node N6. By referencing the node address management table T22, the island master N5 acquires an IP address of the node N6. The island master N5 transmits the IP address of the node N6 while addressing to the IP address of the node N4, included in the login request (provision of a physical address to the node N4). The node N4 receives the IP address of the node N6 from the island master N5. In this way, the node N4 resolves an IP address (the IP address of the node N6) of an establishment destination of a connection for accessing the unaccessed portion of the virtual volume V2.

(S85) The node N4 transmits, to the node N6, a predetermined login request according to a protocol of the iSCSI. The node N6 receives the login request from the node N4. For the node N6 serving as a target, the node N4 functions as an initiator.

(S86) Upon succeeding in authentication based on the login request received in step S85, the node N6 establishes a connection with the node N4.

(S87) The node N4 issues, to the node N6, an IO request for the virtual volume V2. The IO request may include, for example, information of the virtual volume V2, an LBA range of an access destination in the virtual volume V2, and so forth.

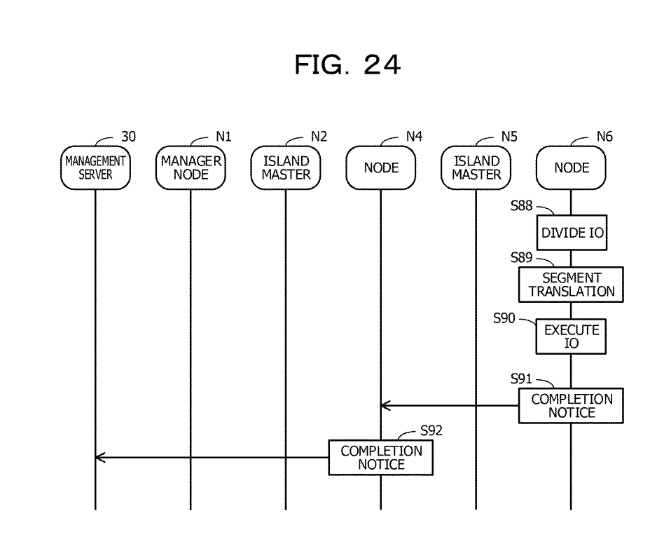

FIG. 24 is a diagram illustrating an example of the second sequence (the rest thereof) of the I/O processing. Hereinafter, processing illustrated in FIG. 24 will be described in line with step numbers.

(S88) Based on the translation table T43, the node N6 divides an IO in units of logical segments. A specific method is as exemplified in FIG. 10. Here, the node N6 holds a correspondence relationship between the LBA range in the second portion (a portion belonging to the island 70a) of the virtual volume V2 and logical segments, and by the LBA range of the access destination being specified, the node N6 is able to divide the IO in units of logical segments.

(S89) Based on the translation table T43, the node N6 translates IOs in units of logical segments to IOs in units of physical segments (access destinations of the IOs are translated to physical addresses on individual HDDs).

(S90) By controlling the nodes N5, N6, N7, and N8, the node N6 executes the IO. If the IO is, for example, reading of data, reading of the corresponding data is performed. In addition, if the IO is, for example, writing of data, writing of the corresponding data is performed.

(S91) The node N6 transmits a completion notice of the IO to the node N4. In a case of reading of data, the completion notice includes the read data. In addition, in a case where the IO is writing of data, the completion notice includes a notice of completion of writing. The node N4 receives the completion notice from the node N6.

(S92) The node N4 merges an IO result included in the completion notice received from the node N6 and the IO result held by the node N4 in step S80 and generates and transmits, to the business server 30, an IO result responsive to the IO request from the business server 30. For example, in a case where the IO is reading of data, data obtained by merging a portion read in step S80 and a portion acquired in step S91 is transmitted, as read data, to the business server 30. In addition, in a case where the IO is writing of data, a writing result obtained by merging a writing result of a portion written in step S80 and a writing result acquired in step S91 (for example, entire writing succeeds, writing fails in a portion, or the like) is transmitted to the business server 30.

In this way, it is possible for each of nodes to adequately process a request to access the virtual volume V2, received from the business server 30.

Note that, in the IO execution in step S90, an unaccessed portion occurs in some cases (a case where an access destination straddles 3 or more islands). In that case, the node N6 performs the I/O processing as follows. In the following description, it is assumed that an island master of the third island is the island master N9. In addition, it is assumed that, in the third island, a node in charge to be in charge of accesses to a virtual volume to serve as an access target is a node N10.

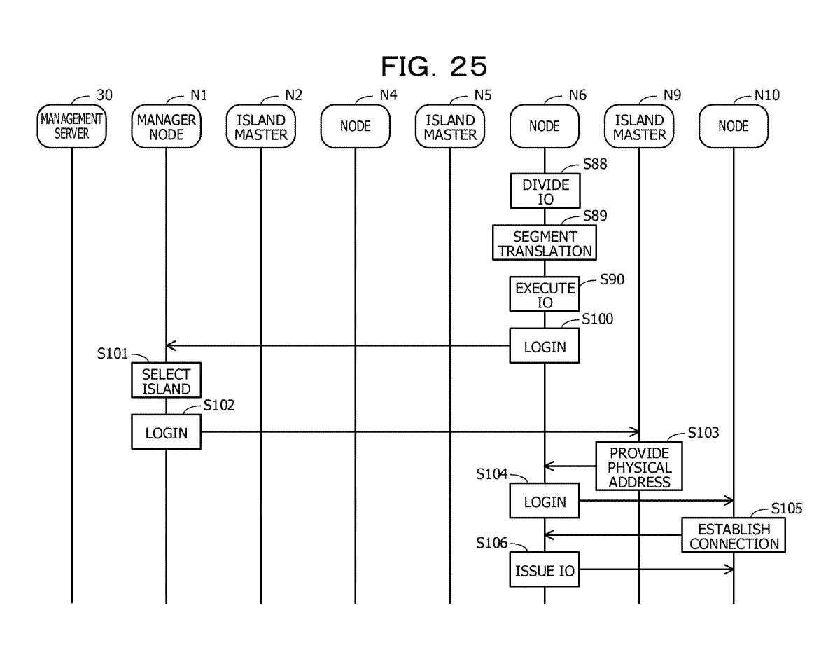

FIG. 25 is a diagram illustrating an example of a third sequence of I/O processing. Hereinafter, processing illustrated in FIG. 25 will be described in line with step numbers. Here, in FIG. 25, a case where an unaccessed portion occurs in the I/O processing in step S90 in FIG. 24 is exemplified. In other words, it is a case where an IO for a virtual volume to straddle 3 islands including the islands 70 and 70a is requested by the business server 30. Since a procedure of I/O processing for portions belonging to the respective islands 70 and 70a of the relevant virtual volume is the same as the method described in FIGS. 23 and 24, descriptions up to step S90 will be described. In this regard, however, in the procedure in FIG. 25, in step S90, the node N6 holds, in a RAM or the like, a portion already accessed by the node N6.

(S100) In order to perform an IO on an unaccessed portion of a virtual volume serving as an access target, the node N6 transmits a login request to the manager node N1. The relevant login request includes, for example, a virtual volume serving as an access destination, an access start LBA in an LBA range of the relevant virtual volume corresponding to the unaccessed portion, and the IP address of the node N6 serving as a transmission source IP address. The manager node N1 receives the login request from the node N6.

(S101) Based on information included in the login request received in step S100 and the virtual volume management table T12, the manager node N1 selects the third island. By referencing the island master address management table T11, the manager node N1 acquires an IP address of the island master N9 of the selected island (a transfer destination address of the login request).

(S102) The manager node N1 transfers the login request to the island master N9. The island master N9 receives the login request transferred by the manager node N1.

(S103) By referencing a node-in-charge management table, the island master N9 identifies that a node in charge of the virtual volume to serve as an access destination included in the login request is the node N10. By referencing a node address management table, the island master N9 acquires an IP address of the node N10. The island master N9 transmits the IP address of the node N10 while addressing to the IP address of the node N6, included in the login request (provision of a physical address to the node N6). The node N6 receives the IP address of the node N10 from the island master N9. In this way, the node N6 resolves an IP address (the IP address of the node N10) of an establishment destination of a connection for accessing the unaccessed portion of the virtual volume.

(S104) The node N6 transmits, to the node N10, a predetermined login request according to a protocol of the iSCSI. The node N10 receives the login request from the node N6. For the node N10 serving as a target, the node N6 functions as an initiator.

(S105) Upon succeeding in authentication based on the login request received in step S104, the node N10 establishes a connection with the node N6.

(S106) The node N6 issues, to the node N10, an IO request for the virtual volume. The IO request may include, for example, information of the virtual volume, an LBA range of an access destination in the virtual volume, and so forth.

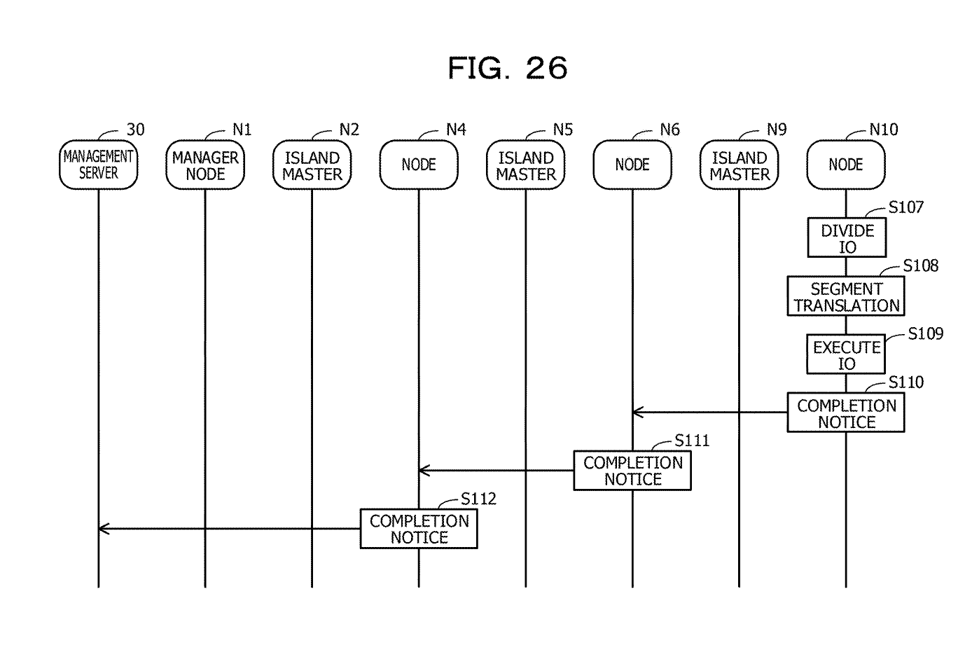

FIG. 26 is a diagram illustrating an example of the third sequence (the rest thereof) of the I/O processing. Hereinafter, processing illustrated in FIG. 26 will be described in line with step numbers.

(S107) Based on a translation table held by the node N10, the node N10 divides an IO in units of logical segments.

(S108) Based on the translation table, the node N10 translates IOs in units of logical segments to IOs in units of physical segments (access destinations of the IOs are translated to physical addresses on individual HDDs).

(S109) By controlling individual nodes belonging to the island to which the node N10 belongs, the node N10 executes the IO. If the IO is, for example, reading of data, reading of the corresponding data is performed. In addition, if the IO is, for example, writing of data, writing of the corresponding data is performed.

(S110) The node N10 transmits a completion notice of the IO to the node N6. In a case of reading of data, the completion notice includes the read data. In addition, in a case where the IO is writing of data, the completion notice includes a notice of completion of writing. The node N6 receives the completion notice from the node N10.

(S111) The node N6 merges an IO result included in the completion notice received from the node N10 and the IO result held by the node N6 and generates and transmits, to the node N4, a completion notice responsive to the IO request from the node N4.

(S112) The node N4 merges an IO result included in the completion notice received from the node N6 and the IO result held by the node N4 and generates and transmits, to the business server 30, an IO result responsive to the IO request from the business server 30.

In this way, each of nodes sequentially asks a node in charge belonging to a subsequent island to access an unaccessed portion of a virtual volume in a case where the relevant unaccessed portion exists in an IO request in the self-island. In addition, each of nodes creates a final IO result by using the node N4 and responds to the business server 30 therewith. In this way, it is possible for each of nodes to adequately process an access to a virtual volume to straddle 3 or more islands.

Here, processing in FIGS. 22 to 26, based on the manager node N1, is performed by the manager processing unit 130. In addition, processing in FIGS. 22 to 26, based on each of the island masters, is performed by a master processing unit included in a controller unit of the relevant island master. It may be considered that processing operations other than those are performed by I/O processing units in respective controller units.

Next, procedures of I/O processing operations, based on respective nodes and used for realizing processing operations corresponding to step S58 to step S61 in FIG. 22, step S78 (FIG. 23) to step S92 (FIG. 24), and step S88 (FIG. 25) to step S112 (FIG. 26), will be described.

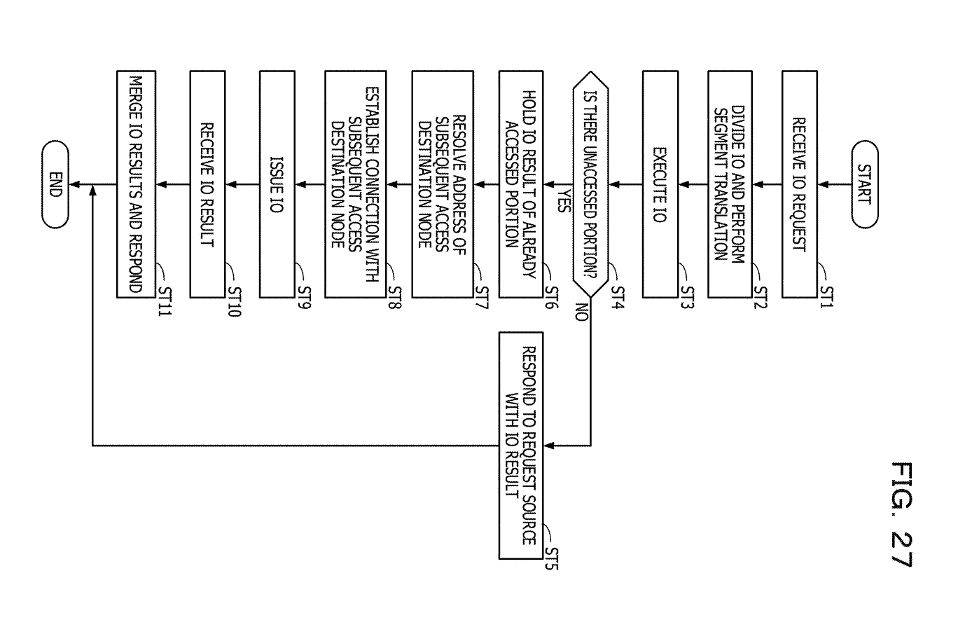

FIG. 27 is a flowchart illustrating an example of I/O processing based on a node in charge. Hereinafter, processing illustrated in FIG. 27 will be described in line with step numbers. While, hereinafter, the processing procedure of the I/O processing unit 120 is mainly described, the I/O processing units of the other nodes each perform the same processing.

(ST1) The I/O processing unit 120 receives an IO request.

(ST2) Based on a translation table held by the node itself (in this case, the node N1), the I/O processing unit 120 divides an IO in units of logical segments and translates logical segments of access destinations to physical segments (addresses on individual HDDs).

(ST3) The I/O processing unit 120 executes the IO, thereby acquiring an IO result.

(ST4) For the IO request received in step ST1, the I/O processing unit 120 determines whether or not there is an unaccessed portion. In a case where there is no unaccessed portion, the processing proceeds to step ST5. In a case where there is an unaccessed portion, the processing proceeds to step ST6.

(ST5) The I/O processing unit 120 responds to an IO request source with the IO result acquired in step ST3. In addition, the processing is terminated.

(ST6) The I/O processing unit 120 stores and holds, in the memory unit 110, the IO result of an already accessed portion, acquired in step ST3.

(ST7) The I/O processing unit 120 resolves an IP address of a subsequent access destination node. Specifically, the I/O processing unit 120 notifies the manager processing unit 130 of identification information of a virtual volume, a leading LBA of the unaccessed portion in the virtual volume, and an IP address of the node itself (node N1). Then, based on the island master address management table T11 and the virtual volume management table T12, the manager processing unit 130 transfers a login request to an island master for accessing the corresponding leading LBA of the corresponding virtual volume. In addition, as a response to the login request, the I/O processing unit 120 receives the IP address of the subsequent access destination node from the relevant island master.

(ST8) The I/O processing unit 120 executes login according to a protocol of the iSCSI or the like for the subsequent access destination node (hereinafter, simply called an access destination node) and establishes a connection with the access destination node. Note that, depending on a protocol (for example, in a case of using an FC, or the like), login does not have to be executed, in some cases.

(ST9) By using the established connection, the I/O processing unit 120 issues an IO to the access destination node.

(ST10) For the IO issued in step ST9, the I/O processing unit 120 receives an IO result from the access destination node.

(ST1) The I/O processing unit 120 merges the IO result held in step ST6 and the IO result received in step ST10 and responds to the request source of the IO request received in step ST1, with a completion notice of an access, which includes the relevant IO results.

In this way, the controller units of nodes each execute an IO for the virtual volume. In a case where, in particular, an IO straddles islands, individual controller units execute the IO in internal coordination. Therefore, in a case where an IO request received from the business server 30 straddles islands, it is possible to adequately process an IO without interrupting it.

In addition, the storage system of the second embodiment has the advantage that it is possible to reduce a startup interval of time of each of shelves. Specifically, first the shelf SH1 including the node N1 to serve as an island manager is started up, and after that, the node N1 starts a service for providing in parallel individual shelves and a virtual volume in units of islands. Since it is possible to perform start-up processing in parallel, it is possible to reduce a time to the start-up of the service.

In addition, for example, it is possible to perform, in units of islands, rearrangement of data (movement of the data from an existing storage unit to a new storage unit), which is to be performed after scaling out. By performing data rearrangement confined to an island, it is possible to keep the movement amount of data at a small amount, and it is possible to make a period of time of the data rearrangement shorter than a case where the rearrangement of data is performed in an entire storage unit without using an island configuration.

Furthermore, the storage system of the second embodiment has the advantage that it is possible to localize the influence of a failure. Even if, for example, one of nodes becomes difficult to use, it is possible to restrict, to an island, a range subjected to the influence thereof. Therefore, it is possible to reduce an influence on a business operation of a user, compared with a case of not using the island configuration.

Note that the control units 11b and 12b are each caused to execute a program, thereby enabling information processing based on the first embodiment to be realized. In addition, processors included in respective controller units are each caused to execute a program, thereby enabling information processing based on the second embodiment to be realized. It may be thought that the storage control devices 11 and 12 and individual controller units each include a computer including a processor and a RAM. The program may be recorded in the computer-readable recording media 81 and 84.

By distributing, for example, the recording media 81 and 84 recording therein the program, it is possible to distribute the program. In addition, the program may be stored in another computer, and the program may be distributed via a network. The computers may each store (install), in a memory device such as the RAM 102 or the NVRAM 103, the program recorded in, for example, the recording medium 81 or 84 or the program received from the other computer and may each read, from the relevant memory device, and execute the program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage system comprising:
a plurality of storage device groups;
a first processor coupled to a first storage device groups included in the plurality of storage device groups and the first processor configured to:
acquire a first access result by accessing a first logical storage area included in a combined logical storage area upon receiving a first access request for the combined logical area, the combined logical storage area being a logical storage area combined the first logical storage area and a second logical storage area, the first logical storage area being a logical storage area corresponding to the first storage device groups, the second logical storage area being a logical storage area corresponding to a second storage device groups included in the plurality of storage device groups, the first access request being transmitted from an access source device;
transmit a second access request for an unaccessed area in the combined logical storage area; and
transmit, upon receiving a second access result corresponding to the second access request, a third access result corresponding to the first access request to the access source device based on the first access result and the second access result; and
a second processor coupled to the second storage device groups and the second processor configured to:
acquire the second access result by accessing the second logical storage area corresponding to the unaccessed area upon receiving the second access request; and
transmit the second access result to the first processor.

2. The storage system according to claim 1, further comprising:
a third processor coupled to a third storage device groups included in the plurality of storage device groups and the third processor configured to:
manage an address of the second storage control device in charge of an access to a third logical storage area corresponding to a third storage device groups included in the plurality of storage device groups, the third logical storage area being included in the unaccessed area and being different from the second logical storage area; wherein
the first processor acquires, from the third processor, an address of a transmission destination of the second access request.

3. The storage system according to claim 2, further comprising:
a fourth processor configured to:
transfer, in response to a coupling request specifying a logical block of an access destination in the third logical storage area, the coupling request to the third processor; wherein
the first processor is further configured to:
transmit the coupling request to the fourth processor to specify the address of the transmission destination of the second access request; and
acquire, in response to the coupling request, the address of the transmission destination of the second access request from the third processor.

4. The storage system according to claim 1, wherein
the first processor is further configured to:
establish a connection with the second storage control device before transmitting the second access request to the second storage control device.

5. The storage system according to claim 2, wherein
the second processor configured to:
transmit a third access request for the third logical storage area to a fifth processor; and
transmit, in response to receiving a fourth access result corresponding to the third request from the fifth processor, transmit the second access result including the fourth access result to the first processor; wherein
the storage system further comprises:
a fifth processor coupled to the third storage device groups and the fifth processor configured to:
acquire the fourth access result by accessing the third logical storage area corresponding to the unaccessed area upon receiving the third access request; and
transmit the fourth access result to the second processor.

6. A storage control device that is used for a storage system including a plurality of storage device groups, the storage control device comprising:
a memory; and
a processor coupled to a first storage device groups included in the plurality of storage device groups and the processor configured to:
acquire a first access result by accessing a first logical storage area included in a combined logical storage area upon receiving a first access request for the combined logical area, the combined logical storage area being a logical storage area combined the first logical storage area and a second logical storage area, the first logical storage area being a logical storage area corresponding to the first storage device groups, the second logical storage area being a logical storage area corresponding to a second storage device groups included in the plurality of storage device groups, the first access request being transmitted from an access source device;
transmit a second access request for an unaccessed area in the combined logical storage area to another storage control device coupled to the second storage device groups; and
transmit, upon receiving a second access result corresponding to the second access request transmitted from the another storage control device, a third access result corresponding to the first access request to the access source device based on the first access result and the second access result.

7. An access control method executed by a storage control device in a storage system that includes a plurality of storage device groups, the access control method comprising:
acquiring a first access result by accessing a first logical storage area included in a combined logical storage area upon receiving a first access request for the combined logical area, the combined logical storage area being a logical storage area combined the first logical storage area and a second logical storage area, the first logical storage area being a logical storage area corresponding to the first storage device groups, the second logical storage area being a logical storage area corresponding to a second storage device groups included in the plurality of storage device groups, the first access request being transmitted from an access source device;
transmitting a second access request for an unaccessed area in the combined logical storage area to another storage control device coupled to the second storage device groups; and
transmitting, upon receiving a second access result corresponding to the second access request transmitted from the another storage control device, a third access result corresponding to the first access request to the access source device based on the first access result and the second access result.
